(19) United States
(12) Patent Application Publication
(10) Pub. No.: US 2003/0225654 A1
(43) Pub. Date: Dec. 4, 2003

(54) Method and system for forecasting agricultural commodity prices in presence of price supports

(75) Inventors: Jean-Paul Chavas, Madison, WI (US); Kwansoo Kim, Madison, WI (US)

Correspondence Address: PATRICIA SMITH KING, SUITE 22, 222 NORTH MIDVALE BOULEVARD, MADISON, WI, 537055072

(73) Assignee: Wisconsin Alumni Research Foundation, Madison, WI

(21) Appl. No.: 10/160,852

(22) Filed: Jun. 3, 2002

(51) Int. Cl. G06F 17/60

(52) U.S. Cl. 705/36; 705/10

(57) ABSTRACT

A method and system provide a process and means for using a general-purpose computer to transform data representing past agricultural commodity market prices, stock amounts and support prices, into forecasts of future market prices and price volatilities to use to aid in allocating industrial and technological resources in the management and procurement of the commodities and stocks thereof. Governmental price supports and stock effects are explicitly incorporated while price volatility varies over time, thereby reflecting short-term changes in market conditions. Non-linear model specifications and forecasting functions jointly incorporate price support and time-series analysis into a dynamic censored-regression model of a commodity market. A version further enables the incorporation of price effects among linked commodity markets.

### BACKGROUND

The present invention relates to a method and system for accurately forecasting the market price and price volatility of agricultural commodities in the presence of governmental support pricing.

An industry's ability to minimize error and risk in its allocation of resources in the management and procurement of agricultural commodities and stocks thereof, depends upon its ability to accurately predict the future market price and price volatility of those commodities. For agricultural commodities under governmental price supports, the support price is a factor influencing their market prices and price volatilities. For example, under relatively high support prices, the market price generally closely tracks the support price making the task of predicting market prices an easy one. This is illustrated in FIG. 1, where an example is presented of the high positive correlation between U.S. support prices (i.e. price floors) set for butter, and the actual market prices when the support prices are relatively high (i.e. until the mid-1990's). Similar direct correlations between market prices and support prices are seen across other agricultural commodity types as well when support prices are high. Generally, there is little challenge in predicting market prices when support prices are high.

However, since the mid 1990's, there has been a trend toward lower support prices for agricultural commodities, breaking the link with market price, increasing price volatility (i.e. market instability) and making the task of prediction and the ability of an industry to timely manage and trade in those commodities more difficult. It also makes it difficult for governmental regulators to predict the effects of their support price policies on the stability of the agricultural commodity markets. As can be seen by way of example in FIG. 1, the lowering of U.S. support prices for butter in the mid-1990's resulted in a break in direct correlation with market prices disabling prediction of market price based on support price alone. Market price volatility also increased with the lowering of support prices. Under low support prices, industries cannot rely on the support price alone as a realistic predictor of market prices and price volatilities, though it remains a factor.

Another result of this trend is to increase the importance of stocks in the overall management scheme of private industries. As governmental support prices decrease, the proportion of stocks held publicly by governments decreases while the proportion held by private industries increases because the government is not obligated to purchase the commodities unless market prices fall below the support price. The overall result is to increase the importance of stocks of commodities in an industry's economy and to increase the need for accurate forecasts upon which their procurement, use and sales management decisions may be based. Private stocks of commodities may be used by an industry in trade generally or to assure its supplies for use in the making of its products. However used, an industry's ability to ensure adequate supplies, minimize costs and maximize profits relies on its ability to optimally manage commodity stocks. And that ability relies on accurate forecasts of future commodity market prices, especially under conditions of high price volatility resulting from a decrease in governmental price supports. With accurate forecasts, an industry may optimally time its commodity procurement, stocking and sales decisions and may minimize its risk knowing how a market's volatility will change over time.

The amount of stocks of commodities, in addition to support price, influences future prices. Under market equilibrium, the interaction between supply and demand determines market prices. When there is no storage, one expects price fluctuation to be a function of supply and demand shocks such as weather and consumer income. However, in the presence of stocks, there is an incentive for inventory change in response to changes in prices. The theory of competitive market prices in the presence of stocks suggests that storage behaviors may affect price dynamics and reduce price volatility. In the presence of commodity stocks, the commodity's market price is then determined by the interactions between supply, demand and storage behavior. Market price volatility, in addition to market price, varies over time with the amount of stocks and other factors. Attempts have been made to develop methods to predict the market price and price volatility of agricultural commodities.

Information relevant to attempts to address modeling agricultural commodities without incorporation of time-series analysis to enable forecasting can be found generally in Tomek, William G. and Kenneth L. Robinson, Agricultural Product Prices, Cornell University Press, 1990, and Holt, M. T. and S. R. Johnson, Bounded Price Variation and Rational Expectations in an Endogenous Switching Model of the U.S. Corn Market, Review of Economics and Statistics, 71(1989): 605-613. Other works focusing on incorporation of time-series analyses in censored-regression models, but without application to agricultural markets and without incorporating price supports, include Lee, Lung-Fei, Estimation of Dynamic and ARCH Tobit Models, J. Econometrics, 92(1999): 355-390; Pesaran, M. H. and H. Samiei. An Analysis of the Determination of Deutche Mark/French Franc Exchange Rate in a Discrete-Time Target Zone, The Economic J., 102(1992): 388-401, and Estimating Limited-Dependent Rational Expectations models with an Application to Exchange Rate Determination in a Target Zone, J. of Econometrics, 53(1992): 141-163; Wei, Steven X., A Bayesian Approach to Dynamic Tobit Models, Econometric Review 18(1999): 417-439; and, Zeger, S. L. and R. Brookmeyer, Regression Analysis with Censored Autocorrelated Data, J. of the Am. Statistical Assoc., 81(1986): 722-729.

These attempts have generally employed standard time-series analyses, such as the auto regressive integrated moving average (ARIMA) analysis (for standard reference on time series analyses of this sort see, James D. Hamilton, Time Series Analysis, 1994, Princeton Univ. Press). However, these time series models suffer from one or more of the following disadvantages: (a) they do not take into consideration governmental price support policies by failing to explicitly incorporate the support price effects as discussed above, and thus fail to account for the censoring effects of support price on market price; (b) they are generally linear and therefore fail to provide a realistic prediction of market dynamics because the support price set by a government creates a non-linear dynamic in the market; (c) they sometimes assume price volatility to be constant (conditional heteroscedastic models being a notable exception); and (d) though some have considered multiple prices in related commodity markets (e.g., using vector autoregression, VAR), they have done so as linear analyses without explicitly incorporating price supports.

For the foregoing reasons, there is a need for a method for forecasting short-term fluctuations in the market price and price volatility of agricultural commodities that explicitly incorporates governmental price support and stock effects while recognizing that price volatility varies over time. A method that can solve the technical problem of doing so, can provide an industry a market price forecast and measure of market stability to use to minimize its market risk and to optimize the allocation of its resources in the procurement, stocking, use and sale of those same commodities. A method that can further incorporate price effects among related, dependent commodity markets, can improve the accuracy of the price and volatility forecasts in those markets.

### SUMMARY

The present invention is directed to satisfying this need by providing a method and system for using a general-purpose computer to transform data representing past discrete commodity market prices, stock amounts and governmental support prices, into accurate forecasts of future market prices and market stability as reflected by price volatilities. Governmental price supports and stock effects are explicitly incorporated while price volatility varies over time, thereby reflecting short-term changes in market conditions. This is accomplished by employing non-linear model specifications and forecasting functions developed by the novel approach of jointly incorporating price support and time-series analysis into a dynamic censored-regression model of an agricultural commodity market. In this way the method provides predictions of market prices and price volatilities that are both realistic and accurate. One version of the method further enables the incorporation of price effects among linked commodity markets (i.e., commodities whose market dynamics are dependent, for example, butter, non-fat dry milk and cheese) to further improve the accuracy of the forecasted price dynamics of those markets.

In both cases, the invention produces the useful, concrete and tangible result of accurate short-term forecasted market prices and price volatilities for agricultural commodities under price supports. An industry can use these realistic and accurate forecasts of market prices and volatilities to minimize risk and error in its allocation of resources and in its timely management and trade of those commodities and stocks thereof. Governments can use the forecasts to evaluate the effects of proposed changes in price support policies on the markets of affected commodities.

In one version, the method of using a computer for forecasting a future market price of an at least one agricultural commodity for which a governmental support price is set comprises: providing for the specification of a plurality of parameters of a price function to define a set of specified price functions for the at least one commodity, the set of specified price functions comprising a censoring regression function explicitly incorporating the support price, a time-series function with a plurality of seasonal dummy variables, and, a time-varying price volatility function; providing for the estimation of a value of each of the plurality of parameters by applying an estimation method to the set of specified price functions using a plurality of data; providing for the solution of a price forecasting function incorporating the plurality of parameter values for a current time interval, thereby forecasting the future market price of the at least one commodity at said time interval, the price forecasting function comprising a dynamic censored-regression function jointly incorporating the price support and a time-series analysis; providing for the accessible storage of a results database in said computer, the results database comprising the future market price of the at least one commodity for the current time interval; and, providing for the output of said future market price to aid in allocating industrial or technological resources employed in the management or trading of said at least one commodity . stocks thereof.

In another version, the method further comprises providing for the creation of an inputs database that comprising: providing a definition of the at least one commodity; providing for the specification of a time frame over which the market price is to be forecasted, the time frame comprising a type of time interval and a number of time intervals; providing the plurality of data from an at least one source database, the data including a set of recent past actual market prices of the at least one commodity, a set of recent past amounts of stocks of the at least one commodity and the support price of the at least one commodity; and, providing for the accessible storage of the inputs database in said computer.

In another version, the method further comprises iteratively repeating the solution of the price forecasting function step over multiple time intervals.

In another version of the method, the price forecasting function solves for the future market price of the at least one commodity at the current time interval by taking an average of an expected price of said commodity under a market regime weighted by a probability of being in a market regime at said time interval, and the support price for said commodity weighted by the probability of being in a government regime at said time interval.

In another version, the method further comprises providing for a market price volatility forecasting function, thereby forecasting the future market price volatility of the commodity at a current time interval.

In another version, the method further comprises solving for the future market price and price volatility across multiple commodities.

In another version, an apparatus is provided having means for performing one or more of the processes described above.

In another aspect, a program storage device, readable by a machine, tangibly embodying a program of instructions executable by the machine is provided to perform one or more of the processes described above.

In another aspect, an article having a computer-usable medium has computer-readable program code embodied in the medium for performing one or more of the processes described above.

In another aspect, a computer program product is provided to perform one or more of the processes described above.

The reader is advised that this summary is not meant to be exhaustive. Further features, aspects, and advantages of the present invention will become better understood with reference to the following description, accompanying drawings and appended claims. In particular, though the invention is described in its application to dairy commodities under price supports, it may also be applied to other types of agricultural commodities under governmental price support programs.

### BRIEF DESCRIPTION OF DRAWINGS

For a better understanding of the present invention, reference may be made to the accompanying drawings, in which:

FIG. 1, shows a graph of the actual price of butter by comparison to the U.S. governmental support price for butter over time and the disconnection between the two resulting from the drop in price supports in the mid-1990's;

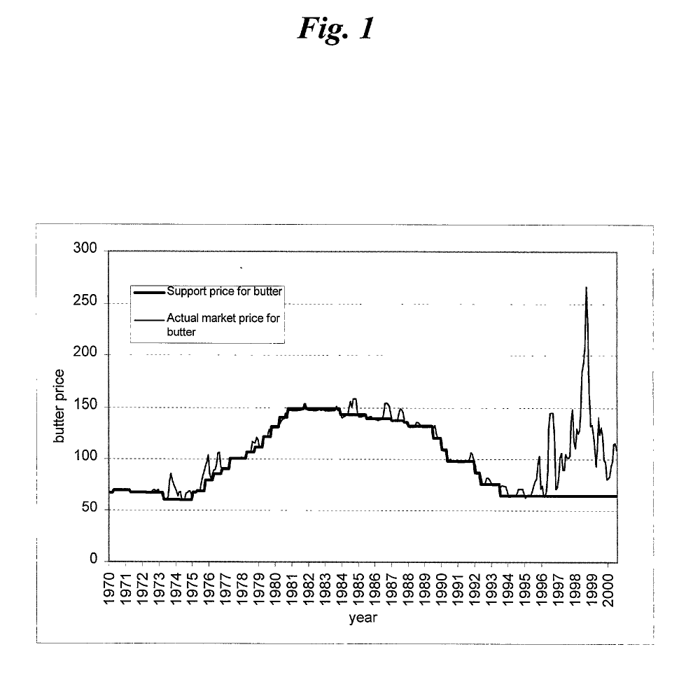

FIG. 2, shows a graph of the actual market price of butter by comparison to the forecasted market price of butter over time, using a version of the method of the present invention;

FIG. 3, shows a flow chart of one version of the method of the invention;

FIG. 4, shows a graph of the forecasted price volatilities of butter price over time;

FIG. 5, shows a block diagram overview of an apparatus, method and system embodying features of the invention;

FIG. 6, shows a graph of the actual historical amounts of commercial and governmental stocks (STC and STG, respectively) of three U.S. dairy commodities: butter, American cheese and non-fat dry milk, as they have varied over time since 1970;

FIG. 7 shows a graph of the actual market prices of linked dairy commodities (butter, non-fat dry milk and American cheese) by comparison to their forecasted market prices over time, using a version of the method of the present invention; and,

FIG. 8, shows a graph of forecasted price volatilities across the multiple linked commodities of butter, non-fat dry milk and American cheese.

### DESCRIPTION

Referring now specifically to the figures, in which identical or similar parts are designated by the same reference numerals throughout, a detailed description of the present invention is given. It should be understood that the following detailed description relates to the best presently known embodiment of the invention. However, the present invention can assume numerous other embodiments, as will become apparent to those skilled in the art, without departing from the appended claims. For example, though the present invention is illustrated in application to certain dairy commodities, it may be applied to other types of agricultural commodities under governmental price support programs such as corn, wheat, or others.

It should also be understood that, while the methods disclosed herein may be described and shown with reference to particular steps performed in a particular order, these steps may be combined, sub-divided, or re-ordered to form an equivalent method without departing from the teachings of the present invention. Accordingly, unless specifically indicated herein, the order and grouping of the steps is not a limitation of the present invention.

Overview

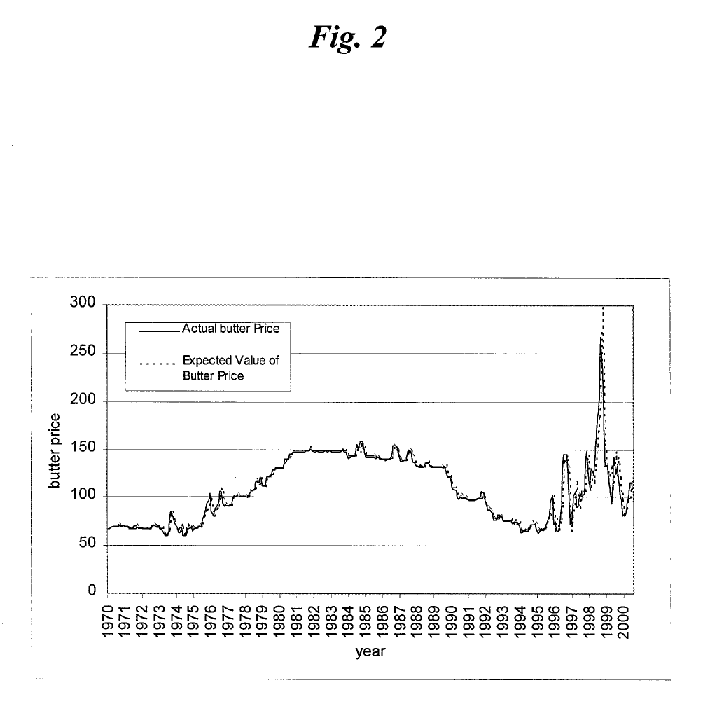

The present invention is directed to satisfying the above-described needs by providing a method and system for predicting agricultural commodity market price and price volatility. The method employs a non-linear analysis and incorporates price supports under variable price volatility. In this way, the censoring effect of price support programs is captured improving the realism of the method's predictions of market prices and price volatility over other methods which do not incorporate price supports. Referring to FIG. 2, the present invention can be seen to provide a highly accurate forecast of market prices and price volatilities. These market price and price volatility forecasts may be used to aid in optimally allocating industrial or technological resources employed in the management and trading of the commodity and stocks thereof.

The method of the present invention provides situation-specific forecasts over relatively short-terms. It works well over the shorter term because the method allows for changes in market conditions (which are likely to change in the shorter term), while holding price support level constant (reflecting the fact that support price is unlikely to change over the shorter term).

One version of the method and system of the present invention, further enables the simultaneous analysis of multiple-commodities whose market dynamics are dependent (e.g. butter, non-fat dry milk, cheese).

The time frame of the forecasts depends on the type of time interval of the current set of input data. For example, where input data are available on a monthly basis (i.e. the time interval is a month as is the case for many dairy commodities where data on the market price and amount of stock is available on a monthly basis), the method may be used to produce forecasts over a 5 to 10 month time frame (i.e. over 5 to 10 time intervals). Where the input data are available on a weekly basis, forecasts over a 5 to 10 week time frame may be generated. Where input data are available on a yearly basis (as with corn, wheat, etc.), generating forecasts over a 5 to 10 year time frame may be possible—though in this case, realistically fewer years depending on frequency of changes to support price programs.

A version of the method according to the present invention for forecasting market prices and price variations generally comprises the steps of creating an inputs database 200; specifying price functions 250 [Eqs. (3a)-(3c) or (3a)′-(3c)′]; estimating the value of the parameters by solving the specified price functions 300; forecasting a future market price and price volatility of the commodity by solving price and volatility forecasting functions 400 [Eqs. (2a)-(2b) or (2a)′-(2b)′]; storing the forecasted values in a results database 490 for use in minimizing risk and optimally allocating industrial or technological resources employed in the management or trading of the commodity and stocks thereof. The results database may be further queried by an end user to enable customized output and analyses according to the user's needs.

A version of the system according to the present invention provides means for performing the above-described functions and processes.

Detailed Description—Single Commodities

Forecasting Functions—Single Commodity [Eqs. (2a) and (2b)].

A commodity's market price and price volatility are predicted by forecasting functions (i.e. price forecasting and volatility forecasting functions) developed by considering a commodity market where the market price for the commodity is subject to a government price support program. The forecasting function for the average market price of a commodity is given at Eq. (2a) below (i.e. the price forecasting function). The forecasting function for the variance in the market price, or price volatility, is given at Eq. (2b) below (i.e. the volatility forecasting function). The forecasting functions represent an econometric model (here, a Tobit or censored-regression model) that explicitly incorporates support price and that allows for endogenous regime switching (i.e. switching between market and government regimes, see below at discussion of Eq. (1a)) and time varying volatility of prices (i.e. variance of prices) where the amount of stocks affects both the mean expected, or forecasted, market price and the variance of prices, or price volatility. A background to the development of the functions and an explanation of the functions themselves follow.

The econometric model investigating the process of market price determination in the presence of a government price support program is here developed. Under market equilibrium, the interaction between supply and demand determines market prices. When there is no storage (i.e. no stocks), one expects market price fluctuation to be a function of supply and demand shocks such as weather and consumer income. However, in the presence of stocks, there is an incentive for stock inventory change in response to changes in prices. The theory of competitive market prices in the presence of stocks suggests that storage behaviors affect price dynamics and reduce price volatility. Then, in the presence of commodity stocks, the commodity's market price is determined by the interactions between supply, demand and storage behavior. Let yₜ* be the market price for a commodity at time interval t in the absence of government intervention. Denote the supply function for that commodity at time interval t by S(yₜ*, ·) and the demand function (including both final demand and demand for stocks) by M(yₜ*, ·), then the market equilibrium price yₜ* satisfies S(yₜ*, ·)=M(yₜ*, ·). Solving this market equilibrium condition for yₜ* gives the reduced form equation

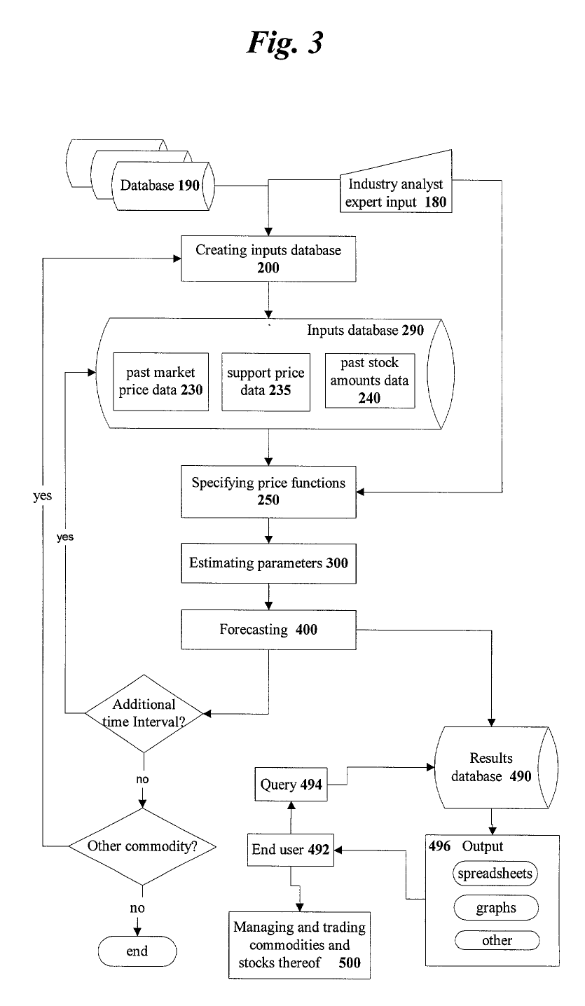

yₜ*=f(Xₜ, β)+eₜ,

where Xₜ is a vector of explanatory variables including past market prices 230 and previous amounts of stock inventory 240, β is a (k×1) vector of unknown parameters to be estimated (see specifying and estimating steps 250 and 300, FIG. 3), and eₜ is an error term distributed as N(0, σₜ²), where σₜ is a time-varying standard deviation. The parametric price function f(Xₜ, β), represents the price determination process in the absence of price support.

Incorporating price support. A government price support program is introduced in this market. The observed market price at time interval t, yₜ, is defined as

$$\begin{matrix}{y}_{t} = {y}_{t}^{*} if {y}_{t}^{*} > {s}_{t} \\ = {s}_{t} if {y}_{t}^{*} \leq {s}_{t} ,\end{matrix}$$

where sₜ is a known positive constant at time interval t denoting the level of support price at time interval t. Note that in this specification, the price support program is characterized by a support price sₜ reflecting government policy at time interval t. When yₜ>sₜ, the price support is inactive. However, if yₜ<sₜ then a government agency intervenes in the market and buys (and usually stores) the commodity at a price sₜ. This effectively creates a perfectly elastic demand at price sₜ, thus preventing any decrease in the market price below sₜ. The observed market price yₜ is then determined according to the reduced form model:

yₜ=max{yₜ*, sₜ} (1a)

yₜ=f(Xₜ, β)+eₜ (1b)

where eₜ is an error term normally distributed with mean zero and variance σₜ².

Equations (1a)-(1b) constitute a Tobit, or censored regression, econometric model where the dependent variable market price, yₜ, is censored at the support price, sₜ, at time interval t. Let Iₜ=1 if yₜ*>sₜ, and Iₜ=0 otherwise. From (1a), the latent variable yₜ is observed only if Iₜ=1 (i.e., yₜ* is the market price at time interval t in the absence of government intervention). This corresponds to the “market regime” where the latent price is the market price (yₜ=yₜ*) and the government price support program is inactive. Alternatively, yₜ* is censored and unobserved if Iₜ=0. This corresponds to the “government regime” where the price support program determines the market price (with yₜ=sₜ).

Equation (1a)-(1b) thus are price functions that provide a generic model of price determination in the presence of a price support program, allowing for endogenous regime switching between the “market regime” and the “government regime.” Equations (1a) and (1b) give the reduced form for price determination.

Placing in context of time-series analysis. Dynamic components are next introduced to put the censored-regression model in which price support has been explicitly incorporated [i.e., Eqs. (1a) and (1b)] in the context of a time-series analysis. Putting the censored-regression model in the context of time-series analysis applied to a market under price supports is novel (see Eqs. (2a) and (2b) below). Incorporating time-series analysis in the previously available censored-regression model, improves the model for use for a new application, namely forecasting.

Let Xₜ=(Yₜ, xₜ), where Yₜ=(yₜ₋₁, yₜ₋₂, . . . , yₜ₋ₘ) is a vector of m lagged (i.e. past) market prices 230, and xₜ denotes other explanatory variables. This gives a convenient and flexible representation of dynamics in the presence of censoring.

Possible changes in price volatility are examined by allowing for a time-varying standard deviation σₜ. If the price level includes a risk premium, it can be captured by including in the explanatory variables, xₜ, the time-varying standard deviation σₜ. This establishes a censored regression model with time-varying conditional variance (a.k.a. a heteroscedastic Tobit model). Price volatility is not a constant, but a variable in the forecasting functions, enabling reflection of short-term changes in market conditions. Thus, the model can be used to predict changes in market volatility (i.e. stability of the market) for use in an industry's or government's assessment of risk.

The equations (1a) and (1b) can be estimated by standard maximum likelihood estimation or an alternative estimation method such as a quasi-maximum likelihood method or the like.

The specification (1a) and (1b) for the mean and variance of market price yₜ has implications. Let hₜ=[sₜ−f(Xₜ, β)]/σₜ, where hₜ reflects the degree of censoring at time interval t. Denote the probability that the censored variable yₜ* is unobserved by Prob(Iₜ=0)=Prob[eₜ<sₜ−f(Xₜ, β)]=Φ(hₜ), where Φ(·) is the standard normal distribution function. Then, from Eqs. (1a)-(1b), the expected or forecasted value of the market price at time interval t, E(yₜ), is calculated by the price forecasting function:

$$\begin{matrix}E ( {y}_{t} ) = Prob ( {I}_{t} = 1 ) \cdot [ f ( {X}_{t} , β ) + E ( {e}_{t} \vert {e}_{t} > {s}_{t} - f ( {X}_{t} , β ) ) ] + Prob ( {I}_{t} = 0 ) \cdot {s}_{t} , \\ = [ 1 - Φ ( {h}_{t} ) ] \cdot f ( {X}_{t} , β ) + {σ}_{t} \cdot φ ( {h}_{t} ) + Φ ( {h}_{t} ) \cdot {s}_{t} ,\end{matrix} \qquad ( 2 a )$$

where E(eₜ[eₜ>sₜ−f(Xₜ, β))]=σₜ·φ(hₜ)/(1−Φ(hₜ)), φ(·) being the density function of the standard normal variable. Expression (2a) gives the intuitive result that expected market price E(yₜ) is a weighted average of the support price sₜ and of the expected market price conditional on Iₜ=1. The weights involve the probability of censoring, Φ(hₜ), e.g., the probability of facing the government regime at time interval t.

In summary, the future market price at a time interval t, E(yₜ), equals a weighted average of two prices, an expected price under a market regime, f(Xₜ, β)+σₜ·φ(hₜ)/[1−Φ(hₜ)], weighted by a probability of being in that regime, [1−Φ(hₜ)], and the support price, sₜ, weighted by a probability of being in a government regime, Φ(hₜ).

Forecasts may be extended out for an appropriate period of time by solving (2a) for the value of expected future prices, E(yₜ₊ⱼ), j=1, 2 . . . months or other specified time frame. The time frame is defined as a type of time interval (e.g. month, week, year) and a number of time intervals, j. When j=1, a static forecast is generated, i.e., a prediction of market price at one future time interval. When j>1, a dynamic forecast is generated, i.e., a prediction of market price over a time frame comprising more than one time interval. In that case, each new time interval analyzed generates a new market price for that time interval which is added to the historical price data 230 prior to analyzing the next time interval (see time interval loop in FIG. 3). For example, if j=3 (i.e. time frame is 3 time intervals), the equation (2a) is solved at time interval 1 generating a market price that is added to the past market prices 230 prior to solving Eq. (2a) at time interval 2. Likewise, the market price at time interval 2 becomes a past market price 230 in the solution of Eq. (2a) at time interval 3. Also updated between intervals are other variables of Eqs. (2a) and also (2b) below, such as σₜ, f(Xₜ, β), and others. Thus the solution of the price forecasting function, Eq. (2a), is iteratively repeated for each of the time intervals and the inputs database 290 is updated with the previously forecasted future market price between each iteration. Similarly, the solution of the price volatility forecasting function, Eq. (2b) (see below), is likewise iteratively repeated with the inputs database 290 updated with previous forecasted volatilities between iterations.

The forecasted variance of market price at time interval t, yₜ, or price volatility, is calculated by the novel volatility forecasting function:

V(yₜ)=σₜ²·[1−Φ(hₜ)+hₜ·φ(hₜ)+hₜ²·Φ(hₜ)−[hₜ·Φ(hₜ)+φ(hₜ)]²] (2b)

Equation (2b) implies that the relative variance [V(yₜ)/σₜ²] equals [1−Φ(hₜ)+hₜ·φ(hₜ)+hₜ²·Φ(hₜ)−[hₜ·Φ(hₜ)+φ(hₜ)]²]: it measures the impact of censoring from the price support program on price volatility. For example, in the absence of censoring, the relative variance would equal 1. Alternatively, under censoring (i.e., under the government regime), the relative variance [V(yₜ)/σₜ²] is reduced, indicating how a price support program would decrease price volatility.

Forecast may be extended out for an appropriate period of time by solving (2b) for the value of expected future price volatility, V(yₜ₊ⱼ), j=1, 2 . . . months or other specified time interval. As described above in regard to Eq. (2a), when j=1, a static forecast is generated, i.e., a prediction of market price volatility at one future time interval. When j>1, a dynamic forecast is generated, i.e., a prediction of market price volatility over more than one time interval.

The price and volatility forecasting functions, equations (2a) and (2b), appropriately represent the dynamic of the market as non-linear, reflecting that the local dynamics vary depending on the point of evaluation. To see this, consider the simple specification for (1b): f(·)=a₀+a₁ yₜ₋₁. Then, using (2a), ∂Eyₜ/∂yₜ₋₁=a₁·[1−Φ(hₜ)]+∂Φ(hₜ)/∂yₜ₋₁·[sₜ−fₜ]+σₜ∂φ(hₜ)/∂yₜ₋₁. The functions Φ(·) and φ(·), are non-linear functions of lagged prices. The forecasting functions, equations (2a) and (2b), thus represent the novel joint incorporation of price support and time-series analysis into a dynamic censored-regression model of an agricultural commodity market. The joint incorporation of price support providing a censoring mechanism and time-series analysis enabling dynamic forecasting with the censored-regression model, results in novel forecasting functions able to more accurately predict the market prices and price volatilities of agricultural commodities in the presence of price supports.

The realism of the forecasting functions is further improved by the novel price functions specified in step 250 below [i.e. equations (3a) to (3c)]. The specified price functions explicitly incorporate support price and provide an extension of standard autoregression models by incorporating censoring and time-varying conditional variance.

Specifying the Price Functions 250—Single Commodity [Eqs. (3a) to (3c)].

Solving the forecasting functions [Eqs. (2a) and (2b)] to forecast market prices and price volatility (see forecasting step 400), requires that the commodity price function, f(Xₜ, β) in equation (1b), first be specified 250 for the commodity or commodities of concern. The values for the parameters of the resulting specified price functions [Eqs. (3a) to (3c), see below] are then estimated 300 to provide values for f(Xₜ, β) and σₜ used in the solution of the forecasting functions [Eqs. (2a) and (2b)].

Industry analyst or expert input 180 is generally employed to specify the parametric function f(Xₜ, β) representing the price determination process in the absence of price support in the market at issue (see FIG. 3). This parametric specification is supported by a database that will allow the estimation of the corresponding 13 parameters (see step 300). This section describes how the price function in (1b) is specified 250 according to the particular commodity and market under investigation, resulting in the specified price functions of equations (3a) to (3c). These price functions may alternatively be provided pre-specified for given commodities in known markets (for example, pre-specified price functions for butter, non-fat dry milk and American cheese in the U.S. market may be provided).

In specifying the price functions, the variables and parameters in Eq. (1b) are specified according to the particular commodity and market under consideration. The following example of the specifying step 250, applies to the commodities of butter, non-fat dry milk or American cheese, as the agricultural commodity under investigation. However, similar specifications may be made for other commodities under governmental price supports including other dairy commodities, field crops (e.g. corn, wheat) or other commodities under governmental price supports. Common to different commodities and markets is specifying the time frame (i.e. number and type of time interval(s)) over which the forecasts are to be run and determining whether the analysis will be static or dynamic. Other types of specifications follow.

From the censored-regression (Tobit) specifications of Eqs. (1a)-(1b), consider that

$$f ( \cdot ) = {β}_{0} + {\sum }_{j = 1}^{m} {β}_{j} {y}_{t - j} + {x}_{t} \overline{β} + {e}_{t} , and {σ}_{t} = exp [ {γ}_{0} + {z}_{t} \overline{γ} ] .$$

Note that eₜ is distributed N(0, σₜ²), (β₀, βⱼ, \overline{β}, γ₀ and \overline{γ}) are parameters to be estimated, and zₜ is a vector of explanatory variables affecting σₜ. In the case where \overline{γ}≢0, this allows for time-varying conditional variance (or heteroscedasticity), where zₜ affects the volatility of prices.

Recall that xₜ denotes a vector of explanatory variables that may affect the mean expected market price of a commodity. These variables may generally include:

(a) A time trend TT and seasonal dummy variables (Qᵢ equals 1 for the i-th season, zero otherwise). The time trend TT accounts for the effects of long-term trends and may be defined as monthly or otherwise depending on the time intervals at which a commodity's data are reported. The seasonal dummy variables Qᵢ incorporate seasonality effects in the commodity market. Below, they are treated as quarterly dummy variables. However, alternatives to quarterly dummy variables may be employed depending again on the time frame over which a commodity's data are reported.

(b) The historical amounts of stocks of the commodity, or lagged stocks 240. The lagged stock variable, STₜ₋₁, captures stock effects. From the economics of storage, it is expected that higher (lower) stock at time interval t−1 would tend to reduce (increase) the market price at time interval t. The amount of total stocks may further be specified according to whether the stocks are private of public; and,

(c) The standard deviation of the error term (σₜ) where it is time varying. Here, inclusion of the standard deviation at in xₜ reflects the situation where a risk premium possibly affects the expected value of butter market prices, E(yₜ).

Recall that zₜ denotes a vector of explanatory variables that may affect the variance in market price, or price volatility. As with xₜ, the zₜ vector of explanatory variables includes lagged stock amounts STₜ₋₁ 240 and the time trend TT. In general, the parametric specification σₜ=exp[γ₀+zₜ \overline{γ}] allows the explanatory variables zₜ to affect price variability in a way that is unrelated to the censoring effects of the price support program. In this specification, the change in volatility is treated as “endogenous”. Let zₜ=[STₜ₋₁, f(Xₜ, β)−sₜ, (f(Xₜ, β)−sₜ)·STₜ₋₁, TT], where TT is a time trend capturing long term changes in volatility. Lagged amount of stock STₜ₋₁ 240 captures the effects of lagged stock amounts on the standard deviation at. And [f(Xₜ, β)−sₜ] is the difference between the expected latent price and the support price. When positive (negative), this difference would likely correspond to the market regime (government regime). In this specification, the impact of the expected price difference [f(Xₜ, β)−sₜ] on σₜ is allowed to vary with the stock level. This motivates the introduction of the interaction variable [(f(Xₜ, β)−sₜ)·STₜ₋₁] among the zₜ variables.

In the above specification for σₜ, the lagged stock variable STₜ₋₁ reflects the effects of stocks on price volatility. From the economics of storage, larger (smaller) stocks may be expected to generate lower (higher) price volatility. As such, the above Tobit model specification incorporates the effects of stocks on both mean market price, E(yₜ), and price volatility, V(yₜ) in the butter market (i.e. the forecasted market price and price volatility).

The following three equations reflect endogenous structural change in price volatility and constitute the econometric specifications described above. They are heteroscedastic dynamic Tobit models. The specified price functions for single commodities are:

a censoring regression function explicitly incorporating the support price (equivalent to Eq. (1a));

yₜ=max{yₜ*, sₜ} (3a)

a time-series function with seasonal dummy variables (expanded version of Eq. (1b) incorporating time series analysis and with variables and parameters specified);

$$\begin{matrix}{y}_{t}^{*} ≡ {f}_{2} ( {X}_{t} , β ) + {e}_{t} \\ = {β}_{0} + {β}_{T} TT + {β}_{Q1} {Q}_{1} + {β}_{Q2} {Q}_{2} + {β}_{Q3} {Q}_{3} + \\ {\sum }_{k = 1}^{m} {β}_{k} {y}_{t - k} + {β}_{S} {ST}_{t - 1} + {e}_{t} ,\end{matrix} \qquad ( 3 b )$$

a time-varying price volatility function;

σₜ=exp[γ₀+γ₁TT+γ₂STₜ₋₁+γ₃(f₂(Xₜ, β)−sₜ)+γ₄((f₂(Xₜ, β)−sₜ)·STₜ₋₁)] (3c)

where sₜ is a support price for the commodity, yₜ* is the latent commodity price at time interval t, and eₜ is an error term distributed N(0, σₜ²). In the absence of censoring (where yₜ*=yₜ), equation (3b) would reduce to standard autoregressive models of order m, AR(m), with the time trend TT, seasonal dummies (Q₁, Q₂, Q₃), lagged stock STₜ₋₁. As such, the reduced form Eqs. (3a)-(3c) provide an extension of such models in the presence of censoring and time-varying conditional variance. Furthermore, Eq. (3a) explicitly incorporates support price, sₜ. Given inputs data 290, the parameters in the specified price functions [Eqs. (3a)-(3c)] are estimated 300 by the maximum likelihood estimation method or an alternative estimation method such as a quasi-maximum likelihood method or the like. This yields estimated values for the specified parameters including f(Xₜ, β) and σₜ, to use in solving the forecasting functions [Eqs. (2a) and (2b)] to forecast market prices and price volatilities 400.

Creating the Inputs Database 200—Single Commodity.

An inputs database 290 may be created from industry expert or analyst input 180 and data available from one or more public or private databases 190. Industry expert or analyst input 180 may generally include a definition of the one or more agricultural commodities for which the forecasts are to be generated. The databases 190 may generally include historical commodity market price data 230 (i.e. yₜ₋₁, yₜ₋₂, . . . , yₜ₋ₘ), support price data 235 (i.e. sₜ), historical amounts of stock data 240 (i.e. STₜ₋₁) and information relating to the frequency of data reporting for use in establishing values for the time trend, TT. Databases 190 may include the U.S. Department of Agriculture (USDA) for U.S. dairy commodities market price data and National Agricultural Statistics Service and Agricultural Stabilization and Conservation Service, USDA, for past amounts of stock data, among other sources depending on the commodity and country.

Creating the inputs database 200 involves downloading data from the databases 190, combining those data with data input by an industry expert or analyst input 180 and processing the data from both to the extent necessary to prepare the inputs database 290. Processing may generally include putting the raw data into spreadsheet format (such as Excel file format) thereby transforming the data for use in an econometric analysis package. The data in the inputs database 290 is thereby accumulated and formulated for use in estimating 300 and forecasting 400.

Estimating Parameters 300−Single Commodity.

Values for the parameters used in the specified price functions [Eqs. (3a)-(3c)] are estimated. Assuming that the error terms eₜ are serially uncorrelated, estimation of the parameters β₀, βⱼ, \overline{β}, γ₀ and \overline{γ} is obtained using the maximum likelihood estimation method (or an alternative estimation method such as a quasi-maximum likelihood method or the like) applied to Eqs. (3a)-(3c) using data from the inputs database 290 including the support price sₜ 235, historical market prices yₜ₋₁, yₜ₋₂, . . . , yₜ₋ₘ (i.e., m lagged market prices 230), and historical amounts of stocks, STₜ₋₁ 240. Statistical testing for serial correlation is performed as a model validation exercise.

The choice of the order of the AR process (m) in (3b) was-made using the Schwarz criterion. This involves choosing m so as to maximize [1n(maximum likelihood)−K·1n(T)/2], where K is the number of parameters and T is the number of observations. The Schwarz criterion chose m=7 for the endogenous structural change model, equations (3a)-(3c). An example of parameters and their estimates is given below in Table 1.

Table 1. Parameter Estimates for Heteroscedastic Dynamic Tobit Models Eqs. 3(a)-3(c): US Butter Price, January 1970-July 2000. Note: Standard errors are provided in parentheses, T denotes the number of observations, and asterisks indicate statistical significance at the 10 percent (*), 5 percent (**), and 1 percent (***) level, respectively.

| | | | Standard |
|---|---|---|---|
| Parameters | Definition | Estimates | Errors |
| β₀ | Intercept | 2.681** | (1.247) |
| βₜ₋₁ | price of butter at time | 1.101*** | (0.061) |
| | interval t-1 | | |
| βₜ₋₂ | price of butter at time | −0.306*** | (0.088) |
| βₜ₋₃ | price of butter at time | 0.130 | (0.089) |
| βₜ₋₄ | price of butter at time | −0.023 | (0.094) |
| βₜ₋₅ | price of butter at time | −0.192* | (0.099) |
| βₜ₋₆ | price of butter at time | 0.096 | (0.095) |
| βₜ₋₇ | price of butter at time | 0.125* | (0.069) |
| β_{S} | Lagged butter stock (STₜ₋₁) | −0.809*** | (0.243) |
| β_{T} | Time trend (TT) | 0.062 | (0.053) |
| β_{Q1} | Dummy for 1^{st} Quarter (Q1) | −3.376*** | (1.000) |
| β_{Q2} | Dummy for 2^{nd} Quarter (Q2) | −2.012* | (1.155) |
| β_{Q3} | Dummy for 3^{rd} Quaffer (Q3) | 2.573*** | (0.771) |
| β_{σ} | Standard deviation (σₜ) | | |
| Intercept | Intercept for the standard | 1.172*** | (0.111) |
| | deviation equation | | |
| γ₁ | Time trend in the 1990s | | |
| γ₂ | Lagged buffer stock (STₜ₋₁) | −0.063** | (0.031) |
| γ₃ | f(Xₜ, β) − sₜ | 0.021*** | (0.004) |
| γ₄ | (f(Xₜ, β) − sₜ) · STₜ₋₁ | −0.005** | (0.002) |
| γ₅ | Time trend (TT) | 0.024*** | (0.006) |

| | |
|---|---|
| T | 360 |
| Log- | −725.23 |
| likelihood | |

Forecasting Market Price and Price Volatility 400—Single Commodity.

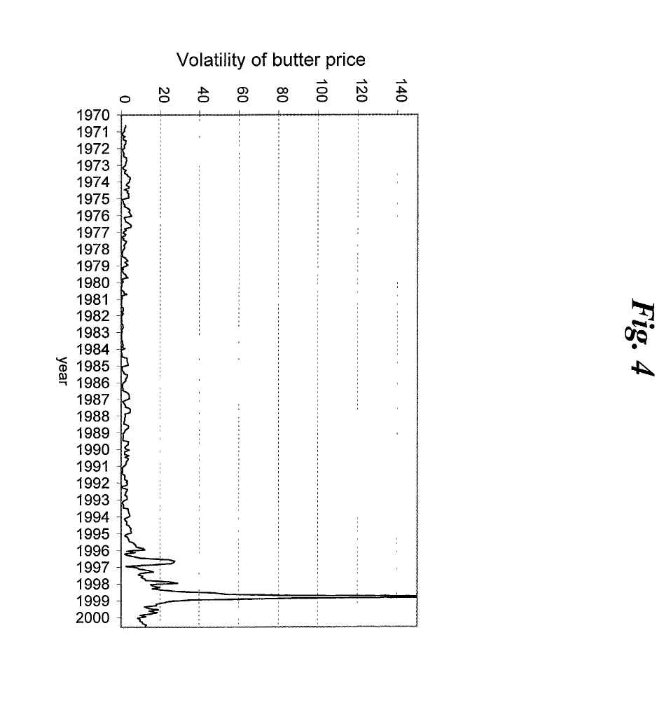

The forecasted average market price at time interval t, E(yₜ), is calculated by solving Eq. (2a) given the value for the price function, f(Xₜ, β), as specified and estimated (at 250 and 300) and actual values for the support price sₜ. Referring to FIG. 2, an example of forecasted prices for butter by comparison with actual prices is given. The accuracy of the forecasting functions is evidenced by the close fit between actual and forecasted values. Similar results have been obtained when forecasting market prices for other dairy commodities such as non-fat dry milk and American cheese. The forecasted variance in market price, or price volatility V(yₜ), is likewise calculated by solving Eq. (2b) (see FIG. 4 for example of forecasted (i.e. expected) variance in butter prices).

The resulting forecasted market price and price volatilities are stored in a results database 490 and available for outputting 496 and querying 494 by an end user 492. The end user 492 may use or further analyze the results to aid in management and trade decisions 500 regarding the commodity analyzed and its stocks.

If forecasts are desired for more than one future time interval (i.e. a dynamic rather than static forecast is desired), the database 290 is updated with price and volatility data from the previous interval's calculations and the steps repeated over the specified number of time intervals (see FIG. 3).

Detailed Description—Multiple Linked Commodities

The detailed description above regarding the methodology for forecasting market price and price volatility for single agricultural commodities is expanded in this section for use when multiple linked commodities are under consideration.

The methodology is applied by way of example to the price dynamics of three linked dairy commodities in the U.S. dairy price support program: American cheese, butter and nonfat dry milk. Cross price effects among these commodities are expected because butter, nonfat dry milk and American cheese are all produced from milk. As a result, they must compete with each other to get access to milk and its components (e.g., fat, protein). Since the price of each dairy commodity is expected to reflect the shadow value of its dairy components, significant price linkages across dairy markets are expected.

Forecasting Functions—Multiple Commodities [Eqs. (2a)′ and (2b)′].

Recall that one version of the method and system of the present invention, enables the simultaneous analysis of multiple-commodities whose market dynamics are dependent (e.g. butter, non-fat dry milk, cheese). These sections describe how this is done.

Expanding on Eqs. (1a) and (1b) above to include multiple linked commodities, we get the equivalent equations (1a)′ and (1b)′ below for the market price in the absence of government support, yⱼₜ*, and the observed market price, yⱼₜ, of the j-th commodity at time interval t, j=1, . . . , n, n being the number of commodities.

The vector of observed market price, yⱼₜ, is defined as follows:

yⱼₜ=max(yⱼₜ*, sⱼₜ), (j=1, 2, . . . , n) (1a)′

where sⱼₜ is a known support price for the j-th commodity at time interval t.

Let yⱼₜ* be the market price for the j-th commodity at time interval t in the absence of government intervention. Solving the market equilibrium condition by equating the supply and demand functions (including the demand for stocks) for yⱼₜ* gives the following reduced-form:

yⱼₜ*=f(Xⱼₜ, βⱼ)+eⱼₜ, (j=1, 2, . . . , n) (1b)′

where Xⱼₜ is a set of explanatory variables including past prices and previous inventory, it is a vector of unknown parameters, and eⱼₜ is an error term distributed N(0, σⱼ²).

When focusing on a single market, equations (1a)′, and (1b)′ can be specified and estimated using a single equation Tobit model. However, when prices (y₁ₜ, . . . . , yₙₜ) are jointly determined, a single equation approach would fail to capture contemporaneous effects of one market on another (e.g., due to non-zero covariance in the error terms eⱼₜ across commodities, j=1, 2, . . . , n). This leads to a consideration of Eq. (1a)′ as a system of n equations Tobit model given by

yₜ*=f(Xₜ, β)+eₜ (1c)′

where yₜ*=(y₁ₜ*, . . . , yₙₜ*)′, yⱼₜ=max(yⱼₜ*, sⱼₜ), j=1, . . . , n, eₜ=(e₁ₜ, . . . , eₙₜ)′ has a multivariate normal distribution N(0, Σₜ), and Σₜ is a (n×n) covariance matrix. The system of Tobit equations in (1c)′ allows for the investigation of cross-market effects through the covariance terms in Σₜ. In addition, to examine possible changes in price volatility, Σₜ in (1c)′ is allowed to be time varying. This means that (1c)′ corresponds to the specification of a system of heteroscedastic Tobit equations. Finally, dynamic components are introduced in the model to investigate dynamic implications of censored distribution under time-varying volatility. This is done by defining Xₜ=(Yₜ, xₜ), where Yₜ=(y_{1,t-1}, . . . , y_{n,t-1}; . . . ; y_{1,t-m}, . . . , y_{n,t-m}) is a vector of m lagged market prices 230 of the n commodities, and xₜ denotes other explanatory variables (including previous stocks 240) at time interval t. This gives a flexible representation of dynamics in the presence of censoring.

Consider sample data involving T observations of n prices over time. The parameter estimates in (1c)′ can be obtained by maximizing the likelihood function of the sample. This involves 2ⁿ different regimes depending on which prices are censored by the support prices. Let Rₜⁱ represent the censoring state under regime i (i=1, 2, . . . , 2ⁿ) at time interval t. Rₜⁱ equals 1 in the i-th censoring regime at time interval t and 0 otherwise. For example, Rₜ¹=1 represents a regime where all the prices are censored at time interval t; Rₜ²=1 where the price of first commodity is uncensored and the remaining prices censored at time interval t; etc, up to regime 2ⁿ where R₂²^{ⁿ}=1 when all commodity prices are uncensored at time interval t. The likelihood function for the t-th observation in (1c)′ being in regime 2ⁿ involves the multivariate normal density function given by

$$\begin{matrix} {L}_{t} ( β , {\sum }_{t} : {R}_{t}^{2 n} = 1 ) = {( 2 π )}^{- n / 2} \vert {\sum }_{t} {\vert}^{- 1 / 2} \\ exp [ ( - 1 / 2 ) {( {y}_{t} - f ( {X}_{t} , β ) )}^{′} {{\sum }_{t}}^{- 1} ( {y}_{t} - f ( {X}_{t} , β ) ) ] ≡ {φ}_{n} ( {y}_{t} ; f ( {X}_{t} , β ) , {\sum }_{t} ) ,\end{matrix} \qquad {( 1 d )}^{′}$$

where φₙ(yₜ; f(Xₜ, β), Σₜ) is the probability density function for the n-multivariate normal random variables with mean f(Xₜ, β) and variance Σₜ. For the other regimes, the likelihood function needs to be modified to account for the presence of censoring due to the price support program. For example, if the t-th observation corresponds to the regime where the first p commodity prices are censored (Rₜ^{P}=1), the likelihood function of the t-th observation is:

$$\begin{matrix}{L}_{t} ( β , {\sum }_{t} : {R}_{t}^{p} = 1 ) = {\int }_{- ∞}^{{s}_{1 t}} … {\int }_{- ∞}^{{s}_{p t}} {φ}_{n} ( {y}_{1} , … , {y}_{p} , \\ {y}_{p + 1 , t ,} … , {y}_{n t} ; f ( {X}_{t} , β ) , {\sum }_{t} ) ⅆ {y}_{p} … ⅆ {y}_{1} .\end{matrix} \qquad {( 1 e )}^{′}$$

We can discompose this expression into the product of probability density functions and distribution functions. First, let yₜ¹=(y₁ₜ . . . , yₚₜ) represent the p censored variables, let yₜ²=(y_{p+1,t}, . . . , yₙₜ) be the vector of uncensored variables, and define μₜ¹=E(yₜ¹*), μₜ²=E(yₜ²*),

$${{\sum }^{11}}_{t} = var ( {y}_{t}^{1 *} ) , {{\sum }^{12}}_{t} = cov ( {y}_{t}^{1 *} , {y}_{t}^{2 *} ) , {{\sum }^{22}}_{t} = var ( {y}_{t}^{2 *} ) .$$

Then (1e)′ can be alternatively expressed as

$$\begin{matrix}{L}_{t} ( β , {\sum }_{t} : {R}_{t}^{p} = 1 ) = {φ}_{n - p} ( {y}_{t}^{2} ; {μ}_{t}^{2} , {{\sum }^{22}}_{t} ) {\int }_{- ∞}^{{s}_{1 t}} … {\int }_{- ∞}^{{s}_{p t}} \\ {φ}_{p} ( {y}^{1} ; {μ}_{t}^{c} ( {y}_{t}^{2} ) , {{\sum }^{c}}_{t} ) ⅆ {y}_{p} … ⅆ {y}_{1} ,\end{matrix} \qquad {( 1 f )}^{′}$$

where

$$\begin{matrix}{μ}_{t}^{c} ( {y}_{t}^{2} ) = {μ}_{t}^{1} {{\sum }^{12}}_{t} {( {{\sum }^{22}}_{t} )}^{- 1} ( {y}_{t}^{2} - {μ}_{t}^{2} ) , and \\ {{\sum }_{t}}^{c} {= {\sum }^{11}}_{t} - {{\sum }^{12}}_{t} {( {{\sum }^{22}}_{t} )}^{- 1} {{\sum }^{21}}_{t}\end{matrix}$$

are the conditional mean and variance of yₜ¹* given yₜ². The first part of (1f)′,

$${φ}_{n - p} ( {y}_{t}^{2} ; {μ}_{t}^{2} , {\sum }_{t}^{22} ) ,$$

is a (n-p)-dimensional normal probability density function. The second part,

$${Φ}_{p} ( {S}_{t}^{1} ; {μ}_{t}^{c} ( {y}_{t}^{2} ) , {\sum }_{t}^{c} ) ≡ {\int }_{- ∞}^{{s}_{1 t}} … {\int }_{- ∞}^{{s}_{pt}} {φ}_{p} ( {y}^{1} ; {μ}_{t}^{c} ( {y}_{t}^{2} ) , {\sum }_{t}^{c} ) ⅆ {y}_{p} … ⅆ {y}_{1} ,$$

is a p-dimensional normal distribution function evaluated at sₜ¹=(s₁ₜ, . . .sₚₜ). In the case where the error terms et are serially independent, Eqs. (1d)′ and (1f)′ are combined to account for all censoring regimes in the following sample log-likelihood function:

$$\begin{matrix}LL ( β , {\sum }_{t} ) = {\sum }_{t = 1}^{T} [ ( {R}_{t}^{2 n} ) ln [ {φ}_{n} ( {y}_{t} ; f ( {X}_{t} , β ) , {\sum }_{t} ) ] + \\ {\sum }_{i = 1}^{{2}^{n} - 1} ( {R}_{t}^{i} ) \{ ln [ {φ}_{n - {p}_{i}} ( {y}_{t}^{i2} ; {μ}_{t}^{i2} {, {\sum }^{i22}}_{t} ) ] + \\ ln [ {Φ}_{{p}_{i}} ( {s}_{t}^{i1} ; {μ}_{t}^{ic} ( {y}_{t}^{i2} ) , {{\sum }^{ic}}_{t} ) ] \} ] ,\end{matrix} \qquad {( 1 g )}^{′}$$

where Φₚ_{₁} (·) is a pᵢ-multivariate normal distribution function corresponding to the pᵢ censored variables in the i-th regime. Note that evaluating the likelihood function in (1g)′ involves at most n-dimensional integrals. This means that, as long as n is not too large (e.g., less or equal to 3), parameter estimates in (1g)′ can be obtained by standard maximum likelihood estimation. For larger numbers of commodities, an alternative estimation method such as a quasi-maximum likelihood method or the like may be more appropriate.

Next, the implications of the censored normal model (1c)′ for the distribution of prices are explored. The resulting equations (2a)′ and (2b)′ represent the forecasting functions for market prices and price volatilities when multiple commodities are under analysis, similarly to equations (2a) and (2b) for single commodities as described above.

First, under censoring, the unconditional expected value of the j-th price yⱼₜ at time interval t is given by the multiple-commodity price forecasting function

$$\begin{matrix}E ( {y}_{jt} ) = Prob ( {D}_{jt} = 1 ) \cdot [ f ( {X}_{t} , {β}_{j} ) + E ( {e}_{jt} \vert {e}_{jt} > {s}_{jt} - f ( {X}_{t} , {β}_{j} ) ) ] + Prob ( {I}_{jt} = 0 ) \cdot {s}_{jt} , \\ = [ 1 - Φ ( {h}_{jt} ) ] \cdot f ( {X}_{t} , {β}_{j} ) + {σ}_{jt} \cdot φ ( {h}_{jt} ) + Φ ( {h}_{jt} ) \cdot {s}_{jt} ,\end{matrix} \qquad {( 2 g )}^{′}$$

where Iⱼₜ an indicator which equals 1 if yⱼₜ*>sⱼₜ, and 0 otherwise, φ(·) and Φ(·) are the density and distribution functions for the standard normal, σⱼₜ²=var(eⱼₜ), and hⱼₜ≡[sⱼₜ−f(Xₜ, βⱼ)]/σⱼₜ. Note that the probability that the censored variable yⱼₜ* is unobserved is denoted by Prob(Iⱼₜ=0)=Prob[eⱼₜ<sⱼₜ−f(Xₜ, βⱼ)]=Φ(hⱼₜ). Expression (2a)′ indicates that expected price E(yⱼₜ) is a weighted average of the support price sⱼₜ and of the expected market price conditional on Iⱼₜ=1, where the weights involve the probability of censoring, Φ(hⱼₜ), i.e. the probability of facing the government regime.

Similarly, the unconditional variance of yⱼₜ, i.e. the multiple-commodity volatility forecasting function is

V(yⱼₜ)=σⱼₜ²·[1−Φ(hⱼₜ)+hⱼₜ·φ(hⱼₜ)+hⱼₜ²·Φ(hⱼₜ)−[hⱼₜ·Φ(hⱼₜ)+φ(hⱼₜ)]²] (2b)′

Using Equation (2b)′, the relative variance is defined to be [V(yⱼₜ)/σⱼₜ²]. The relative variance measures the impact of censoring from the price support program on price volatility. For example, in the absence of censoring, the relative variance would equal 1. Alternatively, under censoring (i.e., under the government regime), the relative variance [V(yⱼₜ)/σⱼₜ²] is reduced, indicating how a price support program in the j-th commodity would decrease price volatility.

Specifying the Price Functions 250—Multiple Commodities [Eqs. (3a)′-(3c)′].

As mentioned at the start of this section, the methodology is applied by way of example to the price dynamics of three U.S. dairy commodities: American cheese, butter and nonfat dry milk. However, similar specifications may be made for other linked agricultural commodities under other governmental price support programs as well.

The determinants of these market prices and their volatility is investigated, with a special focus on the impact of the government price support program and the effects of private and public stocks. As with the single-commodity methodology, the analysis relies on a heteroscedastic multivariate Tobit model that allows for endogenous regime switching and time varying volatility. Here, the amount of stocks, ST, is considered as in the single commodity description above, but an example of how stocks may be subdivided into commercial (STC) and government (STG) stocks is also provided. By considering these separate types of stocks, the methodology may determine their respective affects on both the mean and the variance of prices, further increasing the realism and accuracy of the forecasts.

The following example empirical analysis is based on monthly data for the period January 1970-July 2000. Monthly data on the corresponding wholesale prices 230 and stocks 240 were obtained from USDA.

The multivariate Tobit specification in (1c)′, where the price function

$$f ( {X}_{jt} , {β}_{j} ) = {β}_{0 j} + {\sum }_{k = 1}^{m} {β}_{j , t - k} {y}_{jt - k} + {x}_{t} {β}_{j} + {e}_{jt}$$

for the j-th commodity, j=1, 2, 3, is investigated for this multiple commodity specification. The error term eₜ=(e₁ₜ, e₁₂, e₃ₜ)′ is assumed to be distributed N(0, Σₜ) and serially uncorrelated. The variance Σₜ is decomposed using the Cholesky decomposition as Σₜ=PₜPₜ′, where

$${P}_{t} = [ \begin{matrix}{P}_{11 , t} & {P}_{12} & {P}_{13} \\ 0 & {P}_{22 , t} & {P}_{23} \\ 0 & 0 & {P}_{33 , t}\end{matrix} ] .$$

This guarantees that the variance Σₜ is always positive semi-definite. The terms (P₁₂, P₁₃, P₂₃) are treated as parameters. However, heteroscedasticity is allowed for by considering the specification P_{jj,t}=γ₀ⱼ+zₜ\overline{γⱼ}, j=1, 2, 3 . In the case where \overline{γⱼ}≠0, this allows the explanatory variables zₜ to affect the variance of the error terms and thus the volatility of prices. The parameters β₀ⱼ, β_{j,t-k}, \overline{β}ⱼ, P₁₂, P₁₃, P₂₃, γ₀ⱼ and \overline{γⱼ} are to be estimated. Note that the P₁₂, P₁₃ and P₂₃ parameters capture contemporaneous effects across markets. And the β_{j,t-k} parameters, k=1, . . . , m, enables the investigation of lagged price 230 effects across markets.

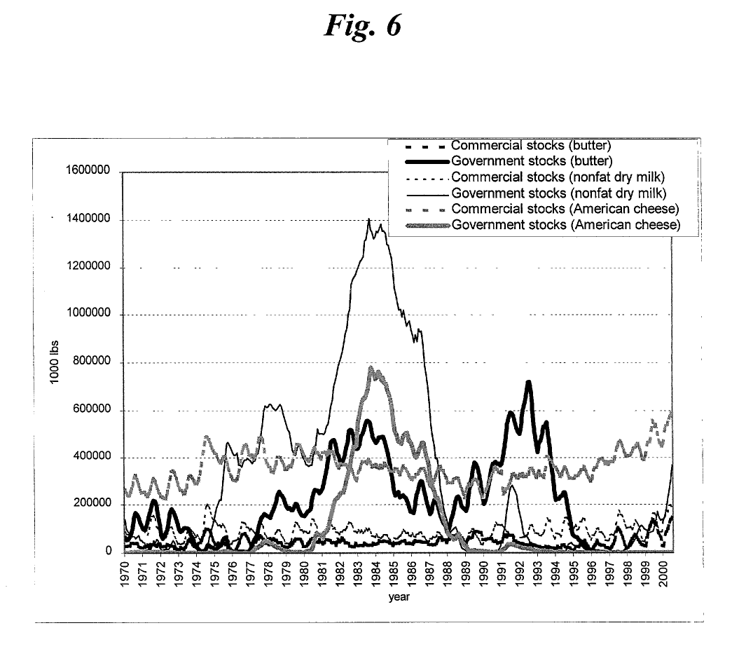

Several refinements are made in the model specification. First, in order to investigate the effects of stocks on the conditional means and variances of dairy market prices, lagged stocks 240 are introduced in xₜ and zₜ. The stock effects are also allowed to differ between private commercial stocks (STC) and public stocks (STG). FIG. 6 shows that private commercial and public stocks (STC and STG) of these three commodities exhibit different patterns over the sample period. As expected, government stocks are high (low) when the price support and government purchases are active (inactive) in the market.

Separately lagged commercial stocks (STCₜ₋₁) and lagged government stocks (STGₜ₋₁) are included in xₜ and zₜ to reflect the differences between commercial and public stock effects on price levels and price volatility. From the economic literature on storage, it is expected that higher (lower) stocks at time interval t−1 would tend to reduce (increase) the market price at time interval t. Also, larger (smaller) stocks are expected to generate lower (higher) price volatility. Second, a time trend TT and quarterly dummy variables (Qᵣ equals 1 for the r-th quarter, zero otherwise) are included in xₜ. The time trend accounts for the effects of long-term trends and the quarterly dummy variables Qᵣ incorporate seasonality effects in dairy markets.

Third, the issue of possible heteroscedasticity in the form of a time varying Σₜ is explored. This would contribute to changing price volatility unrelated to the price support program. As discussed above, the Cholesky decomposition Σₜ=PₜPₜ′, where P_{jj,t}=γ₀ⱼ+zₜ \overline{γⱼ}, j=1, 2, 3, is considered. Introduced in zₜ is a time trend for the 1990s (T90), as well as lagged stock variables. The time trend for the 1990s (T90 equals 1 for 1990, . . . , 11 for 2000, and zero otherwise) is included to capture possible changes in market instability during the 1990s for each commodity. Again, both lagged commercial stocks (STCₜ₋₁) and lagged government stocks (STGₜ₋₁) are included to reflect the different effects of stocks (commercial stock versus government stock) on price volatility. As such, the multivariate Tobit model specification examines the effects of private commercial and public stocks on both mean prices and price volatility in the U.S. dairy markets.

This generates the following specification, the equivalent of Eqs. (3a)-(3c), but for use in the specification step when multiple commodities are under investigation. The multiple-commodity specified price functions:

a censoring regression function explicitly incorporating the support price;

yₜ=max(yₜ*,sₜ) (3a)′

a time-series function with seasonal dummy variables;

$${y}_{t}^{*} = {β}_{0} + {\sum }_{k = 1}^{m} {β}_{t - k} {y}_{t - k} + {x}_{t} β + {e}_{t} , and \qquad {( 3 b )}^{′}$$

a time-varying price volatility function;

var(eₜ)=Σₜ=PₜPₜ′, where P_{jj,t}=γ₀ⱼ+γ₁ⱼT90+γ₂ⱼSTCₜ₋₁+γ₃ⱼSTGₜ₋₁ (3c)′

where yₜ* is a (3×1) vector of latent prices for butter, American cheese and nonfat dry milk, eₜ is an error term with a multivariate normal distribution N(0, Σₜ). In the absence of censoring (where yₜ*=yₜ), equations (3a)′-(3c)′ would reduce to a heteroscedastic vector autoregressive model of order m, VAR(m), with the time trend TT, seasonal dummies (Q₁, Q₂, Q₃), and lagged commercial and public stocks (STCₜ₋₁ and STGₜ₋₁). In this way the model specification accounts for the potentially significant effects of commercial and public stocks on both the mean and variance (volatility) of market prices. The model specification also allows for cross price effects, either contemporaneously (through the covariance terms P_{j′j}, j′≠j) or lagged (through the β parameters measuring the effects of y_{j′,t-k} on yⱼₜ for j≠j′ and k=1, 2).

Thus, the reduced form (3a)′-(3c)′ represents the joint determination process of dairy prices in the presence of censoring under conditional heteroscedasticity. This provides the econometric specification that may be used to forecast market prices and price volatilities in the U.S. dairy markets for the linked commodities of butter, American cheese and non-fat dry milk.

Creating the Inputs Database 200—Multiple Commodities.

An inputs database 290 is created from industry expert or analyst input 180 and data available from one or more public or private databases 190, similarly as described above for single commodities. Industry expert or analyst input 180 may generally include a definition of the linked agricultural commodities for which the forecasts are to be generated. The databases 190 may generally include historical commodity market price data 230 (i.e. yₜ₋₁, yₜ₋₂, . . . , yₜ₋ₘ), support price data 235 (i.e. sₜ), historical amounts of stock data 240 (i.e. STₜ₋₁) and information relating to the frequency of data reporting for use in establishing values for the time trend, TT. For the multiple commodities analysis, these data would comprise market price 230, support price 235 and historical stock 240 data, for each of the specified commodities. Also, stock data may further be subdivided into the amounts of stock held commercially (STC) and governmentally (STG) as considered in the present example.

Databases 190 may include the U.S. Department of Agriculture (USDA) for U.S. dairy commodities market price data and National Agricultural Statistics Service and Agricultural Stabilization and Conservation Service, USDA, for past amounts of stock data, among other sources depending on the commodity and country.

Estimating Parameters 300—Multiple Commodities.

As described for single commodities above, values for the parameters used in the price functions [Eqs. (3a)′-(3c)′] are estimated. In a multi-commodity situation, the main difference from the single-commodity situation involves this parameter estimation step 300. As with the single-commodity estimation, the parameters of the specified price functions are estimated using the maximum likelihood estimation method. However, the joint estimation of parameters in all relevant linked commodity markets makes the estimation more complex when the number of prices increases.

An example of parameters and their estimates is given below in Table 2 using U.S. dairy commodity prices for January 1970 to July 2000. Standard errors are provided in parentheses, T denotes the number of observations, and asterisks indicate statistical significance at the 10 percent (*), 5 percent (**), and 1 percent (***) level, respectively.

| | Butter | | American cheese | | Nonfat dry milk | |
|---|---|---|---|---|---|---|
| Independent | | Std. | | Std. | | Std. |
| variable | Coeff. | error | Coeff. | error | Coeff. | error |
| Intercept | 3.104 | (4.573) | 8.261*** | (2.496) | 7.085* | (4.095) |
| Price dynamics | | | | | | |
| Butter price (PBUₜ₋₁) | 1.259*** | (0.097) | 0.186*** | (0.05) | −0.002 | (0.032) |
| American cheese | 0.013 | (0.191) | 1.130*** | (0.071) | 0.144*** | (0.049) |
| price (PACₜ₋₁) | | | | | | |
| Nonfat dry milk | −0.059 | (0.244) | 0.348*** | (0.073) | 1.286*** | (0.081) |
| price (PNFₜ₋₁) | | | | | | |
| Butter price (PBUₜ₋₂) | −0.36*** | (0.107) | −0.115** | (0.052) | −0.053 | (0.039) |
| American cheese | 0.102 | (0.198) | −0.361*** | (0.062) | −0.044 | (0.065) |
| price (PACₜ₋₂) | | | | | | |
| Nonfat dry milk | −0.07 | (0.232) | −0.187** | (0.088) | −0.448*** | (0.077) |
| price (PNFₜ₋₂) | | | | | | |
| Stock effects | | | | | | |
| Government stock | −0.13*** | (0.052) | −8.025*** | (2.924) | −8.650** | (3.782) |
| (LGSₜ₋₁) | | | | | | |
| Commercial stock | −0.386 | (0.361) | −16.65*** | (5.575) | −54.32*** | (19.78) |
| (LGSₜ₋₁) | | | | | | |

Time trend and seasonality effects

| | | | | | | |
|---|---|---|---|---|---|---|
| Time trend (T) | 0.169 | (0.200) | 0.124 | (0.085) | 0.302** | (0.121) |
| Dummy for 1^{st} | −5.50*** | (1.958) | −0.077 | (0.930) | −3.105** | (1.459) |
| Quarter (Q1) | | | | | | |
| Dummy for 2^{nd} | −1.014 | (2.058) | −0.192 | (0.912) | −1.677 | (1.335) |
| Quarter (Q2) | | | | | | |
| Dummy for 3^{rd} | 5.639*** | (1.879) | 2.931*** | (0.818) | 0.471 | (1.245) |
| Quarter (Q3) | | | | | | |

Heteroscedasticity: Pⱼⱼₜ = γ₀ⱼ + γ₁ⱼ T90 + γ₂ⱼ STG_{j,t-1} + γ₃ⱼ STC_{j,t-1}

| | | | | | | |
|---|---|---|---|---|---|---|
| Intercept γ₀ⱼ | 4.245*** | (1.198) | 2.853** | (1.225) | 8.058*** | (0.702) |
| Time trend γ₁ⱼ | 1.574*** | (0.218) | 0.669*** | (0.107) | −0.259** | (0.107) |
| Government stock | 0.025 | (0.029) | 1.121 | (2.025) | −2.197 | (2.154) |
| γ₂ⱼ | | | | | | |
| Commercial stock | 0.031 | (0.296) | 0.177 | (3.851) | −25.29*** | (8.914) |
| γ₃ⱼ | | | | | | |

Covariance matrix: Σₜ evaluated at sample means

| | | | | | | |
|---|---|---|---|---|---|---|
| Butter | 108.8*** | (17.20) | 17.66*** | (3.562) | 12.848** | (5.887) |
| American cheese | | | 27.76*** | (3.302) | 8.442*** | (2.520) |
| Nonfat dry milk | | | | | 22.54*** | (5.278) |
| Log-likelihood | −1813.84 | | | | | |

Forecasting Market Price and Price Volatility 400—Multiple Commodities.

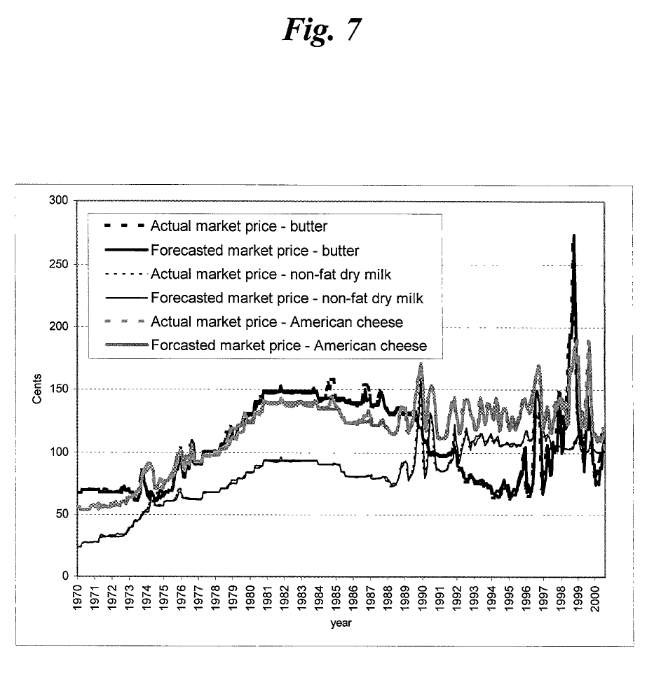

Similarly to single commodities, the forecasted average market prices for multiple commodities at time interval t, E(yₜ), are calculated by solving Eq. (2a)′ given values for the parameters as estimated above at 300 and actual values for the support prices sₜ (see FIG. 7 for example of forecasted (i.e. expected) prices for butter, American cheese and non-fat dry milk).

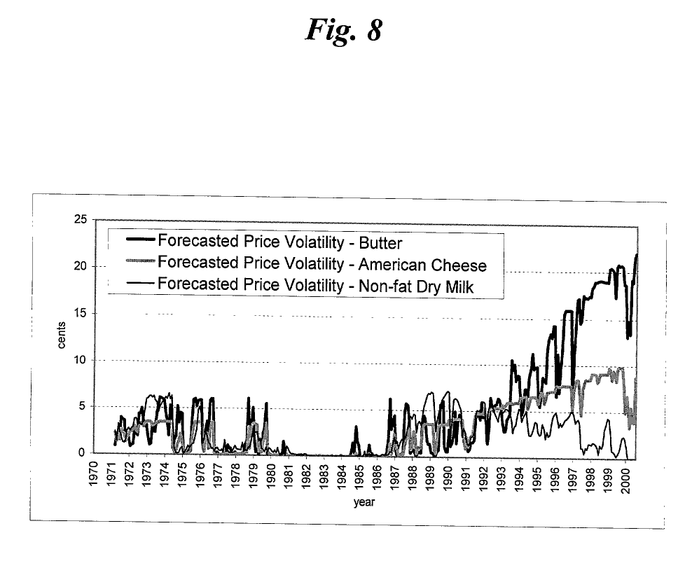

The forecasted variance in market price, or price volatility V(yₜ), is likewise calculated by solving Eq. (2b)′ (see FIG. 8 for example of forecasted variance in butter, non-fat dry milk and American cheese prices).

The resulting forecasted market prices and price volatilities are stored in a results database 490 and available for outputting 496 and querying 494 by an end user 492. The end user 492 may use or further analyze the results to aid in management and trade decisions 500 regarding the commodity analyzed and its stocks.

If forecasts are desired for more than one future time interval (i.e. a dynamic rather than static forecast is desired), the database 290 is updated with price and volatility data for each commodity from the previous interval's calculations and the steps repeated over the specified number of time intervals and over all commodities (see FIG. 3).

Detailed Description—System for Implementing the Method

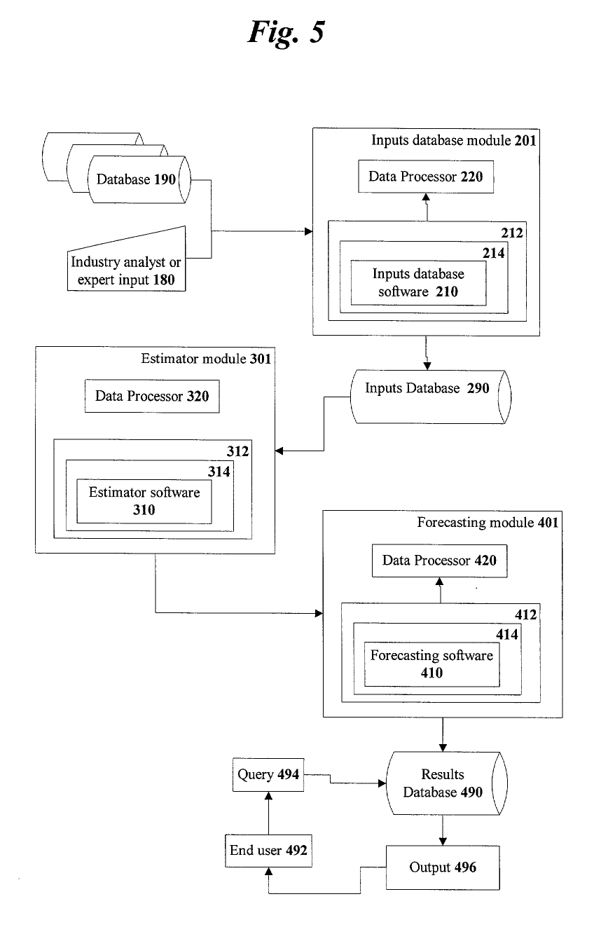

A general-purpose computer, its component devices, and software, provide means for implementing the method steps described above and are generally illustrated in FIG. 5.

In an inputs database module 201, the inputs database 290 is created by inputting, pre-processing, and further manipulating if necessary, the database 190 and industry expert or analyst 180 inputs to the system. The inputs database software 210 resides on a program storage device 212 having a computer usable medium 214 for storing the program code. The program storage device 212 may be of a conventional variety, such as a conventional disk or memory device. The computer usable medium 214 may be a conventional diskette, CD, tape or other similar medium. The inputs database software 210 may be created using general-purpose application development tools such as programming languages, graphical design tools, and commercially available reusable software components. A general database engine may be used to manage inputs data storage and retrieval. The processor 220 is part of a general-purpose computer system. Any general-purpose computer may be used, provided that the processing power is sufficient to achieve the desired speed of computation for the amount of inputs data being processed by the system.

In an estimator module 301, the functions in Eqs. (3a)-(3c) (or Eqs. (3a)′-(3c)′ for multiple commodities) are specified according to step 250 and the parameters estimated according to step 300 in conjunction with estimator software 310 and a data processor 320. The estimator software 310 resides on a program storage device 312 having a computer usable medium 314 for storing the program code. The program storage device 312 may be of a conventional variety, such as a conventional disk or memory device. The computer usable medium 314 may be a conventional diskette, CD, tape or other similar medium. The estimator software 310 may be created using general-purpose application development tools such as programming languages, graphical design tools, and commercially available reusable software components. A general database engine may be used to manage data storage and retrieval. The processor 320 is part of a general-purpose computer system. Any general-purpose computer may be used, provided that the processing power is sufficient to achieve the desired speed of computation for the amount of data being processed by the system.

In a forecasting module 401, the forecasting functions Eqs. (2a)-(2b) (or Eqs. (2a)′-(2b)′ for multiple commodities) are solved according to step 400 in conjunction with forecasting software 410 and a data processor 420. The forecasting software 410 resides on a program storage device 412 having a computer usable medium 414 for storing the program code. The program storage device 412 may be of a conventional variety, such as a conventional disk or memory device. The computer usable medium 414 may be a conventional diskette, CD, tape or other similar medium. The forecasting software 410 may be created using general-purpose application development tools such as programming languages, graphical design tools, and commercially available reusable software components. A general database engine may be used to manage data storage and retrieval.

The processor 420 is part of a general-purpose computer system. Any general-purpose computer may be used, provided that the processing power is sufficient to achieve the desired speed of computation for the amount of data being processed by the system.

It should be noted that, though the inputs database module 201, estimator module 301 and forecasting module 401 may be provided separately as described above, they, and their component parts, may alternatively be combined. That is, the modules (201, 301, and 401) may be provided as combined into a single module in which the respective software (210, 310 and 410) is filly integrated and shares a single program storage device and data processor.

Once the forecast results are stored in the results database 490, they may be used in deciding how to minimize risk and to optimally allocate industrial or technological resources employed in the production, consumption or trading of the commodities and stocks thereof. The results database 490 may be queried by an end user 492 who can request specific information from the system through a query 494 and thereby produce customized output 496. The system accommodates post-processing of the output data 496, allowing delivery in various formats and through various electronic media. The system can generate output 496 in the form of further analyses and presentation as graphs, spreadsheets, HTML documents, or other formats. Queries 494 may be formulated to a user's specifications in order to create customized output to use in making management, procurement and/or trading decisions. The output 496 can be delivered electronically through a variety of channels, including facsimile, e-mail, local area networks (LANs), wide area networks (WANS) and the worldwide web. It can also, of course, be provided in hard copy.

The results database 490 itself, or customized output data 496, may be incorporated into an industry's information management system for intra-net online access (via a LAN or WAN) to enable industry-wide access to forecast results. The industry expert or analyst input 180 may also be supplied via the intra-net information system. In this way, the system of the present invention may be fully incorporated into an industry's information system to provide a seamless interface to their current management, procurement and trading decision-making structure.

Conclusions, Ramifications and Scope

Accordingly it can be seen that the invention satisfies the need for a method and system for accurately forecasting short-term fluctuations in the market price and price volatility of agricultural commodities by explicitly incorporating governmental price supports and allowing price volatility to vary over time, thereby enabling an industry to use the forecasts to aid in optimally allocating its resources in the procurement, stocking, use and sale of those same commodities. The invention further satisfies the need forecasting same for multiple linked commodities.

The reader's attention is directed to all papers and documents which are filed concurrently with this specification and which are open to public inspection with this specification, and the contents of all such papers and documents are incorporated herein by reference.

Although the above description contains many specificities, these should not be construed as limitations on the scope of the invention, but rather as an exemplification of the presently preferred embodiments thereof. The above-described embodiment(s) is set forth by way of example and is not for the purpose of limiting the present invention. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features. It will be readily apparent to those skilled in the art that obvious modifications, derivations and variations can be made to the embodiment without departing from the scope of the invention. Therefore, the spirit and scope of the appended claims should not be limited to the description of the preferred versions contained herein.

I/we claim:

1. A method of using a computer for forecasting a future market price of an at least one agricultural commodity for which a governmental support price is set, to aid in optimally allocating industrial or technological resources employed in the management and trading of said at least one commodity and stocks thereof, the method comprising:
providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
providing for the estimation of a value of each of the plurality of parameters by applying an estimation method to the set of specified price functions using a plurality of data;
providing for the solution of a price forecasting function incorporating the plurality of parameter values for a current time interval, thereby forecasting the future market price of the at least one commodity at said time interval, the price forecasting function comprising a dynamic censored-regression function jointly incorporating the price support and a time-series analysis;
providing for the accessible storage of a results database in said computer, the results database comprising the future market price of the at least one commodity for the current time interval; and,
providing for the output of said future market price to aid in allocating industrial or technological resources employed in the management or trading of said at least one commodity and stocks thereof.

2. The method of claim 1, further comprising providing for the creation of an inputs database, comprising:
providing a definition of the at least one commodity;
providing for the specification of a time frame over which the future market price is to be forecasted, the time frame comprising a type of time interval and a number of time intervals;
providing the plurality of data from an at least one source database, the plurality of data comprising:
a set of recent past actual market prices of the at least one commodity;
a set of recent past amounts of stocks of the at least one commodity;
the support price of the at least one commodity; and,
providing for the accessible storage of the inputs database in said computer.

3. The method of claim 2, further comprising if the number of time intervals is greater than one, iteratively repeating the providing for the solution of the price forecasting function and the providing for the accessible storage of the results database steps for each of said time intervals and updating the inputs database with the previously forecasted future market price between each iteration.

4. The method of claim 2, wherein the amounts of stocks comprise an amount of public stocks and an amount of private stocks.

5. The method of claim 1, wherein the at least one agricultural commodity is a dairy commodity.

6. The method of claim 1, wherein the at least one agricultural commodity is selected from the group consisting of butter, American cheese and non-fat dry milk.

7. The method of claim 1, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

8. The method of claim 1, wherein the estimation method comprises a maximum likelihood method.

9. The method of claim 1, further comprising providing for the solution of a market price volatility forecasting function, thereby forecasting a future market price volatility of the at least one commodity at a current time interval; outputting the future market price volatility; and, wherein the results database further comprises the future price volatility.

10. The method of claim 9, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

11. The method of claim 1, further comprising if more than one commodity is defined, repeating the steps from the providing for the solution of a price forecasting function step for each of the defined commodities where the set of specified price functions comprises a set of multi-commodity specified price functions and the price forecasting function comprises a multi-commodity price forecasting function.

12. The method of claim 11, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

13. The method of claim 11, wherein the at least one commodity comprises butter, American cheese and non-fat dry milk.

14. An apparatus for forecasting a future market price of an at least one agricultural commodity for which a governmental support price is set, to aid in optimally allocating industrial or technological resources employed in the management and trading of said at least one commodity and stocks thereof, the apparatus comprising:
means for providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
means for providing for the estimation of a value of each of the plurality of parameters by applying an estimation method to the set of specified price functions using a plurality of data;
means for providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
means for providing for the accessible storage of a results database in said computer, the results database comprising the future market price of the at least one commodity for the current time interval; and,
means for providing for the output of said future market price to aid in allocating industrial or technological resources employed in the management or trading of said at least one commodity and stocks thereof.

15. The apparatus of claim 14, further comprising means for providing for the creation of an inputs database, comprising:
means for providing a definition of the at least one commodity;
means for providing for the specification of a time frame over which the future market price is to be forecasted, the time frame comprising a type of time interval and a number of time intervals;
means for providing the plurality of data from an at least one source database, the plurality of data comprising:
a set of recent past actual market prices of the at least one commodity;
a set of recent past amounts of stocks of the at least one commodity;
the support price of the at least one commodity; and,
means for providing for the accessible storage of the inputs database in said computer.

16. The apparatus of claim 15, further comprising if the number of time intervals is greater than one, means for iteratively repeating the solution of the price forecasting function for each of said time intervals and means for updating the inputs database with the previously forecasted future market price between each iteration.

17. The apparatus of claim 14, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

18. The apparatus of claim 14, further comprising means for providing for the solution of a market price volatility forecasting function, thereby forecasting a future market price volatility of the at least one commodity at the current time interval; outputting the future market price volatility; and, wherein the results database further comprises the future price volatility.

19. The apparatus of claim 18, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

20. The apparatus of claim 14, further comprising if more than one commodity is defined, means for repeating the solution of the price forecasting function for each of the defined commodities where the set of specified price functions comprises a set of multi-commodity specified price functions and the price forecasting function comprises a multi-commodity price forecasting function.

21. The apparatus of claim 20, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

22. A program storage device readable by a machine, tangibly embodying a program of instructions executable by the machine to perform method steps for forecasting a future market price of an at least one agricultural commodity for which a governmental support price is set, to aid in optimally allocating industrial or technological resources employed in the management and trading of said at least one commodity and stocks thereof, the method steps comprising:
providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
providing for the estimation of a value of each of the plurality of parameters by applying an estimation method to the set of specified price functions using a plurality of data;
providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
providing for the accessible storage of a results database in said computer, the results database comprising the future market price of the at least one commodity for the current time interval; and,
providing for the output of said future market price to aid in allocating industrial or technological resources employed in the management or trading of said at least one commodity and stocks thereof.

23. The program storage device of claim 22, further comprising the step of providing for the creation of an inputs database, comprising:
providing for a definition of the at least one commodity;
providing for the specification of a time frame over which the future market price is to be forecasted, the time frame comprising a type of time interval and a number of time intervals;
providing for the plurality of data from an at least one source database, the plurality of data comprising:
a set of recent past actual market prices of the at least one commodity;
a set of recent past amounts of stocks of the at least one commodity;
the support price of the at least one commodity; and,
providing for the accessible storage of the inputs database in said computer.

24. The program storage device of claim 23, further comprising if the number of time intervals is greater than one, the step of iteratively repeating the solution of the price forecasting function for each of said time intervals and updating the inputs database with the previously forecasted future market price between each iteration.

25. The program storage device of claim 22, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

26. The program storage device of claim 22, further comprising the step of providing for the solution of a market price volatility forecasting function, thereby forecasting a future market price volatility of the at least one commodity at a current time interval; outputting the future market price volatility; and, wherein the results database further comprises the future price volatility.

27. The program storage device of claim 26, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring at time interval t, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

28. The program storage device of claim 22, further comprising if more than one commodity is defined, repeating the solution of the price forecasting function step for each of the defined commodities where the set of specified price functions comprises a set of multi-commodity specified price functions and the price forecasting function comprises a multi-commodity price forecasting function.

29. The program storage device of claim 28, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

30. An article of manufacture comprising a computer-usable medium having computer-readable program code means embodied in said medium for forecasting a future market price of an at least one agricultural commodity for which a governmental support price is set, to aid in optimally allocating industrial or technological resources employed in the management and trading of said at least one commodity and stocks thereof, the computer-readable program code means comprising:
computer readable program code means for providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
computer readable program code means for providing for the estimation of a value of each of the plurality of parameters by applying an estimation method to the set of specified price functions using a plurality of data;
computer readable program code means for providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
computer readable program code means for providing for the accessible storage of a results database in said computer, the results database comprising the future market price of the at least one commodity for the current time interval; and,
computer readable program code means for providing for the output of said future market price to aid in allocating industrial or technological resources employed in the management or trading of said at least one commodity and stocks thereof.

31. The article of manufacture of claim 30, further comprising computer readable program code means for providing for the creation of an inputs database, comprising:
computer readable program code means for providing a definition of the at least one commodity;
computer readable program code means for providing for the specification of a time frame over which the future market price is to be forecasted, the time frame comprising a type of time interval and a number of time intervals;
computer readable program code means for providing the plurality of data from an at least one source database, the plurality of data comprising:
a set of recent past actual market prices of the at least one commodity;
a set of recent past amounts of stocks of the at least one commodity;
the support price of the at least one commodity; and,
computer readable program code means for providing for the accessible storage of the inputs database in said computer.

32. The article of manufacture of claim 31, further comprising if the number of time intervals is greater than one, computer readable program code means for iteratively repeating the solution of the price forecasting function for each of said time intervals and means for updating the inputs database with the previously forecasted future market price between each iteration.

33. The article of manufacture of claim 30, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

34. The article of manufacture of claim 30, further comprising computer readable program code means for providing for the solution of a market price volatility forecasting function, thereby forecasting a future market price volatility of the at least one commodity at a current time interval; computer readable program code means for outputting the future market price volatility; and, wherein the results database further comprises the future price volatility.

35. The article of manufacture of claim 34, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

36. The article of manufacture of claim 30, further comprising if more than one commodity is defined, computer readable program code means for repeating the solution of the price forecasting function for each of the defined commodities where the set of specified price functions comprises a set of multi-commodity specified price functions and the price forecasting function comprises a multi-commodity price forecasting function.

37. The article of manufacture of claim 36, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

38. A computer program product comprising:
a computer usable medium and computer readable code embodied on said computer useable medium for causing the forecasting of a future market price of an at least one agricultural commodity for which a governmental support price is set, to aid in optimally allocating industrial or technological resources employed in the management and trading of said at least one commodity and stocks thereof, the computer-readable code comprising:
computer readable program code devices configured to cause the computer to effect the providing of the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
computer readable program code devices configured to cause the computer to effect the providing of the estimation of a value of each of the plurality of parameters by applying an estimation method to the set of specified price functions using a plurality of data;
computer readable program code devices configured to cause the computer to effect the providing of the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
computer readable program code devices configured to cause the computer to effect the providing of the accessible storage of a results database in said computer, the results database comprising the future market price of the at least one commodity for the current time interval; and,
computer readable program code devices configured to cause the computer to effect the providing of the output of said future market price to aid in allocating industrial or technological resources employed in the management or trading of said at least one commodity and stocks thereof.

39. A method of using a computer for forecasting a future market price of an at least one agricultural commodity for which a governmental support price is set, to aid in optimally allocating industrial or technological resources employed in the management and trading of said at least one commodity and stocks thereof, the method comprising:
providing for the creation of an inputs database, comprising:
providing a definition of the at least one commodity;
providing for the specification of a time frame over which the future market price is to be forecasted, the time frame comprising a type of time interval and a number of time intervals;
providing a plurality of data from an at least one source database, the plurality of data comprising:
a set of recent past actual market prices of the at least one commodity;
a set of recent past amounts of stocks of the at least one commodity; and,
the support price of the at least one commodity;
providing for the accessible storage of the inputs database in said computer;
providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
providing for the estimation of a value of each of the plurality of parameters by applying an estimation method to the set of specified price functions using the plurality of data;
providing for the solution of a price forecasting function incorporating the plurality of parameter values for a current time interval, thereby forecasting the future market price of the at least one commodity at said time interval, the price forecasting function comprising a dynamic censored-regression function jointly incorporating the price support and a time-series analysis;
providing for the accessible storage of a results database in said computer comprising the future market price of the at least one commodity;
if the number of time intervals is greater than one, iteratively repeating the providing for the solution of the price forecasting function and the providing for the accessible storage of the results database steps for each time interval, updating the inputs database with the previously forecasted future market price between each iteration; and,
providing for the output of said future market price to aid in allocating industrial or technological resources employed in the management or trading of said at least one commodity and stocks thereof.

40. The method of claim 39, wherein the at least one agricultural commodity is a dairy commodity.

41. The method of claim 39, wherein the at least one commodity is selected from the group comprising butter, American cheese and non-fat dry milk.

42. The method of claim 39, wherein the amounts of stocks comprise an amount of public stocks and an amount of private stocks.

43. The method of claim 39, wherein the price forecasting function solves for the future market price of the at least one commodity at each of said time intervals by taking an average of an expected price of said commodity under a market regime weighted by a probability of being in the market regime, and the support price for said commodity weighted by the probability of being in a government regime.

44. The method of claim 39, wherein the price forecasting function comprises:
$$\begin{matrix}E ( {y}_{t} ) = Prob ( {I}_{t} = 1 ) \cdot [ f ( {X}_{t} , β ) + E ( {e}_{t} \vert {e}_{t} > {s}_{t} - f ( {X}_{t} , β ) ) ] + Prob ( {I}_{t} = 0 ) \cdot {s}_{t} , \\ = [ 1 - Φ ( {h}_{t} ) ] \cdot f ( {X}_{t} , β ) + {σ}_{t} \cdot φ ( {h}_{t} ) + Φ ( {h}_{t} ) \cdot {s}_{t} ,\end{matrix} \qquad ( 2 a )$$
where the future market price at the time interval t, E(yₜ), equals a weighted average of two prices, an expected price under a market regime, f(Xₜ, β)+σₜ·φ(hₜ)/[1−Φ(hₜ], weighted by a probability of being in that regime, [1−Φ(hₜ)], and the support price, sₜ, weighted by a probability of being in a government regime, Φ(hₜ).

45. The method of claim 39, wherein the estimation method comprises a maximum likelihood method.

46. The method of claim 39, further comprising:
forecasting a market price volatility of the at least one commodity over the specified time frame by solving a price volatility forecasting function;
accessibly storing in said computer the results database further comprising the future price volatility of the at least one commodity over the specified time frame; and,
outputting the future market price volatility to use to aid in minimizing risk in allocating industrial or technological resources employed in the management or trading of said at least one commodity and stocks thereof.

47. The method of claim 46, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

48. The method of claim 39, further comprising if more than one commodity is defined, repeating the steps from the providing for the solution of the price forecasting function step for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

49. The method of claim 48, wherein the multi-commodity price forecasting function iteratively solves for the future market price of the commodity j at the time interval t by calculating a weighted average of an expected price of commodity j under a market regime weighted by a probability of being in the market regime, and the support price of commodity j weighted by a probability of being in a government regime, over all of the at least one commodities.

50. The method of claim 48, wherein the multi-commodity price forecasting function, comprises:
$$\begin{matrix}E ( {y}_{jt} ) = Prob ( {D}_{jt} = 1 ) \cdot [ f ( {X}_{t} , {β}_{j} ) + E ( {e}_{jt} \vert {e}_{jt} > {s}_{jt} - f ( {X}_{t} , {β}_{j} ) ) ] + Prob ( {D}_{jt} = 0 ) \cdot {s}_{jt} , \\ = [ 1 - Φ ( {h}_{jt} ) ] \cdot f ( {X}_{t} , {β}_{j} ) + {σ}_{jt} \cdot φ ( {h}_{jt} ) + Φ ( {h}_{jt} ) \cdot {s}_{jt} ,\end{matrix} \qquad {( 2 a )}^{′}$$
where the future market price of commodity j at the time interval t, E(yⱼₜ), equals a weighted average of two prices, an expected price under a market regime, f(Xₜ, βⱼ)+σⱼₜ·φ(hⱼₜ)/[1−Φ(hⱼₜ)], weighted by a probability of being in that regime, [1−Φ(hⱼₜ)], and the support price, sⱼₜ, weighted by a probability of being in a government regime, Φ(hⱼₜ), over all of the more than one commodity.

51. The method of claim 48, wherein the multi-commodity price volatility forecasting function iteratively solves for the future market price volatility of the commodity j at the time interval t over all of the at least one commodities.

52. The method of claim 48, wherein the multi-commodity price volatility forecasting function comprises:
V(yⱼₜ)=σⱼₜ²·[1−Φ(hⱼₜ)+hⱼₜ·φ(hⱼₜ)+hⱼₜ²·Φ(hⱼₜ)−[hⱼₜ·Φ(hⱼₜ)+φ(hⱼₜ)]²] (2b)′
where σⱼₜ² is a price variance of the commodity j at time interval t in the absence of censoring, and [1−Φ(hⱼₜ)+hⱼₜ·φ(hⱼₜ)+hⱼₜ²·Φ(hⱼₜ)−[hⱼₜ·Φ(hⱼₜ)+φ(hⱼₜ)]²] measures a relative effect of the price support on the price volatility.

53. The method of claim 48, wherein the at least one agricultural commodity comprise butter, American cheese and non-fat dry milk.

54. An apparatus for forecasting a future market price of an at least one agricultural commodity for which a governmental support price is set, to aid in optimally allocating industrial or technological resources employed in the management and trading of said at least one commodity and stocks thereof, the apparatus comprising:
means for providing for the creation of an inputs database, comprising:
means for providing a definition of the at least one commodity;
means for providing for the specification of a time frame over which the future market price is to be forecasted, the time frame comprising a type of time interval and a number of time intervals;
means for providing a plurality of data from an at least one source database, the plurality of data comprising:
a set of recent past actual market prices of the at least one commodity;
a set of recent past amounts of stocks of the at least one commodity; and,
the support price of the at least one commodity;
means for providing for the accessible storage of the inputs database in said computer;
means for providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
means for providing for the estimation of a value of each of the plurality of parameters by applying an estimation method to the set of specified price functions using the plurality of data;
means for providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
means for providing for the accessible storage of a results database in said computer comprising the future market price of the at least one commodity;
if the number of time intervals is greater than one, means for iteratively repeating the solution of the price forecasting function and the accessible storage of a results database steps for each time interval, means for updating the inputs database with the previously forecasted future market price between each iteration; and,
means for providing for the output of said future market price to aid in allocating industrial or technological resources employed in the management or trading of said at least one commodity and stocks thereof.

55. The apparatus of claim 54, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

56. The apparatus of claim 54, further comprising means for providing for the solution of a market price volatility forecasting function, thereby forecasting a future market price volatility of the at least one commodity at a current time interval; outputting the future market price volatility; and, wherein the results database further comprises the future price volatility.

57. The apparatus of claim 54, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

58. The apparatus of claim 56, further comprising if more than one commodity is defined, means for repeating the solution of the price forecasting function for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

59. The apparatus of claim 58, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

60. A program storage device readable by a machine, tangibly embodying a program of instructions executable by the machine to perform method steps for forecasting a future market price of an at least one agricultural commodity for which a governmental support price is set, to aid in optimally allocating industrial or technological resources employed in the management and trading of said at least one commodity and stocks thereof, the method steps comprising:
providing for the creation of an inputs database, comprising:
providing a definition of the at least one commodity;
providing for the specification of a time frame over which the future market price is to be forecasted, the time frame comprising a type of time interval and a number of time intervals;
providing a plurality of data from an at least one source database, the plurality of data comprising:
a set of recent past actual market prices of the at least one commodity;
a set of recent past amounts of stocks of the at least one commodity; and,
the support price of the at least one commodity;
providing for the accessible storage of the inputs database in said computer;
providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
providing for the estimation of a value of each of the plurality of parameters by applying an estimation method to the set of specified price functions using the plurality of data;
providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
providing for the accessible storage of a results database in said computer comprising the future market price of the at least one commodity;
if the number of time intervals is greater than one, iteratively repeating the providing for the solution of the price forecasting function and the providing for the accessible storage of a results database steps for each time interval, updating the inputs database with the previously forecasted future market price between each iteration; and,
providing for the output of said future market price to aid in allocating industrial or technological resources employed in the management or trading of said at least one commodity and stocks thereof.

61. The program storage device of claim 60, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

62. The program storage device of claim 60, further comprising the step of providing for the solution of a market price volatility forecasting function, thereby forecasting a future market price volatility of the at least one commodity at a current time interval; outputting the future market price volatility; and, wherein the results database further comprises the future price volatility.

63. The program storage device of claim 60, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

64. The program storage device of claim 62, further comprising if more than one commodity is defined, repeating the solution of the price forecasting function step for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

65. The program storage device of claim 64, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

66. An article of manufacture comprising a computer-usable medium having computer-readable program code means embodied in said medium for forecasting a future market price of an at least one agricultural commodity for which a governmental support price is set, to aid in optimally allocating industrial or technological resources employed in the management and trading of said at least one commodity and stocks thereof, the computer-readable program code means comprising:
computer readable program code means for providing for the creation of an inputs database, comprising:
computer readable program code means for providing a definition of the at least one commodity;
computer readable program code means for providing for the specification of a time frame over which the future market price is to be forecasted, the time frame comprising a type of time interval and a number of time intervals;
computer readable program code means for providing a plurality of data from an at least one source database, the plurality of data comprising:
a set of recent past actual market prices of the at least one commodity;
a set of recent past amounts of stocks of the at least one commodity; and,
the support price of the at least one commodity;
computer readable program code means for providing for the accessible storage of the inputs database in said computer;
computer readable program code means for providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
computer readable program code means for providing for the estimation of a value of each of the plurality of parameters by applying an estimation method to the set of specified price functions using the plurality of data;
computer readable program code means for providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
computer readable program code means for providing for the accessible storage of a results database in said computer comprising the future market price of the at least one commodity;
if the number of time intervals is greater than one, computer readable program code means for iteratively repeating the solution of the price forecasting function and the accessible storage of a results database steps for each time interval, updating the inputs database with the previously forecasted future market price between each iteration; and,
computer readable program code means for providing for the output of said future market price to aid in allocating industrial or technological resources employed in the management or trading of said at least one commodity and stocks thereof.

67. The article of manufacture of claim 66, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

68. The article of manufacture of claim 66, further comprising computer readable program code means for providing for the solution of a market price volatility forecasting function, thereby forecasting a future market price volatility of the at least one commodity at a current time interval; computer readable program code means for outputting the future market price volatility; and, wherein the results database further comprises the future price volatility.

69. The article of manufacture of claim 68, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

70. The article of manufacture of claim 68, further comprising if more than one commodity is defined, computer readable program code means for repeating the solution of the price forecasting function for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

71. The article of manufacture of claim 70, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

72. A computer program product comprising:
a computer usable medium and computer readable code embodied on said computer useable medium for causing the forecasting of a future market price of an at least one agricultural commodity for which a governmental support price is set, to aid in optimally allocating industrial or technological resources employed in the management and trading of said at least one commodity and stocks thereof, the computer-readable code comprising:
computer readable program code devices configured to cause the computer to effect the providing of the creation of an inputs database, comprising:
computer readable program code devices configured to cause the computer to effect the providing of a definition of the at least one commodity;
computer readable program code devices configured to cause the computer to effect the providing of the specification of a time frame over which the future market price is to be forecasted, the time frame comprising a type of time interval and a number of time intervals;
computer readable program code devices configured to cause the computer to effect the providing of a plurality of data from an at least one source database, the plurality of data comprising:
a set of recent past actual market prices of the at least one commodity;
a set of recent past amounts of stocks of the at least one commodity; and,
the support price of the at least one commodity;
computer readable program code devices configured to cause the computer to effect the providing of the accessible storage of the inputs database in said computer;
computer readable program code devices configured to cause the computer to effect the providing of the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
computer readable program code devices configured to cause the computer to effect the providing of the estimation of a value of each of the plurality of parameters by applying an estimation method to the set of specified price functions using a plurality of data;
computer readable program code devices configured to cause the computer to effect the providing of the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
computer readable program code devices configured to cause the computer to effect the providing of the accessible storage of a results database in said computer comprising the future market price of the at least one commodity;
if the number of time intervals is greater than one, computer readable program code devices configured to cause the computer to effect the iterative repeating of the solution of the price forecasting function and the accessible storage of a results database steps for each time interval and computer readable program code devices configured to cause the computer to effect the updating of the inputs database with the previously forecasted future market price between each iteration; and,
computer readable program code devices configured to cause the computer to effect the providing of the output of said future market price to aid in allocating industrial or technological resources employed in the management or trading of said at least one commodity and stocks thereof.

73. A method of using a computer for forecasting a future market price and a price volatility of an at least one agricultural commodity for which a governmental support price is set, to aid in optimally allocating industrial or technological resources employed in the management and trading of said at least one commodity and stocks thereof, the method comprising:
providing for the creation of an inputs database, comprising:
providing a definition of the at least one commodity;
providing for the specification of a time frame over which the future market price is to be forecasted, the time frame comprising a type of time interval and a number of time intervals;
providing a plurality of data from an at least one source database, the plurality of data comprising:
a set of recent past actual market prices of the at least one commodity;
a set of recent past amounts of stocks of the at least one commodity; and,
the support price of the at least one commodity;
providing for the accessible storage of the inputs database in said computer;
providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
providing for the estimation of a value of each of the plurality of parameters by applying an estimation method to the set of specified price functions using the plurality of data;
providing for the solution of a price forecasting function incorporating the plurality of parameter values for a current time interval, thereby forecasting the future market price of the at least one commodity at said time interval, the price forecasting function comprising a dynamic censored-regression function jointly incorporating the price support and a time-series analysis;
providing for the solution of a market price volatility forecasting function for the current time interval, thereby forecasting a future market price volatility of the at least one commodity at said time interval;
providing for the accessible storage of a results database in said computer comprising the future market price and the future price volatility of the at least one commodity;
if the number of time intervals is greater than one, iteratively repeating the providing for the solution of the price forecasting function, the providing for the solution of the price volatility function and the providing for the accessible storage of the results database steps for each time interval, and updating the inputs database with the previously forecasted future market price and future price volatility between each iteration; and,
providing for the output of said future market price and price volatility to aid in minimizing risk and allocating industrial or technological resources employed in the management or trading of said at least one commodity and stocks thereof.

74. The method of claim 73, wherein the price forecasting function solves for the future market price of the at least one commodity at each of said time intervals by taking an average of an expected price of said commodity under a market regime weighted by a probability of being in the market regime, and the support price for said commodity weighted by the probability of being in a government regime.

75. The method of claim 73, wherein the price forecasting function comprises:
$$\begin{matrix}E ( {y}_{t} ) = Prob ( {I}_{t} = 1 ) \cdot [ f ( {X}_{t} , β ) + E ( {e}_{t} \vert {e}_{t} > {s}_{t} - f ( {X}_{t} , β ) ) ] + Prob ( {I}_{t} = 0 ) \cdot {s}_{t} , \\ = [ 1 - Φ ( {h}_{t} ) ] \cdot f ( {X}_{t} , β ) + {σ}_{t} \cdot φ ( {h}_{t} ) + Φ ( {h}_{t} ) \cdot {s}_{t} ,\end{matrix} \qquad ( 2 a )$$
where the future market price at the time interval t, E(yₜ), equals a weighted average of two prices, an expected price under a market regime, f(Xₜ, β)+σₜ·φ(hₜ)/[1−Φ(hₜ)], weighted by a probability of being in that regime at time interval t, [1−Φ(hₜ)], and the support price, sₜ, weighted by a probability of being in a government regime at time interval t, Φ(hₜ).

76. The method of claim 73, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring at time interval t, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

77. The method of claim 73, wherein the at least one agricultural commodity is a dairy commodity.

78. The method of claim 73, wherein the amounts of stocks comprise an amount of public stocks and an amount of private stocks.

79. The method of claim 73, wherein the estimation method comprises a maximum likelihood method.

80. The method of claim 73, further comprising if more than one commodity is defined, repeating the steps from the providing for the solution of the price forecasting function step for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

81. The method of claim 80, wherein the multi-commodity price forecasting function iteratively solves for the future market price of the commodity j at the time interval t by calculating a weighted average of an expected price of commodity j under a market regime weighted by a probability of being in the market regime, and the support price of commodity j weighted by a probability of being in a government regime, over all of the at least one commodities.

82. The method of claim 80, wherein the multi-commodity price forecasting function, comprises:
$$\begin{matrix}E ( {y}_{jt} ) = Prob ( {D}_{jt} = 1 ) \cdot [ f ( {X}_{t} , {β}_{j} ) + E ( {e}_{jt} \vert {e}_{jt} > {s}_{jt} - f ( {X}_{t} , {β}_{j} ) ) ] + Prob ( {D}_{jt} = 0 ) \cdot {s}_{jt} , \\ = [ 1 - Φ ( {h}_{jt} ) ] \cdot f ( {X}_{t} , {β}_{j} ) + {σ}_{jt} \cdot φ ( {h}_{jt} ) + Φ ( {h}_{jt} ) \cdot {s}_{jt} ,\end{matrix} \qquad {( 2 a )}^{′}$$
where the future market price of commodity j at the time interval t, E(yⱼₜ), equals a weighted average of two prices, an expected price under a market regime, f(Xₜ, βⱼ)+σⱼₜ·φ(hⱼₜ)/[1−Φ(hⱼₜ)], weighted by a probability of being in that regime, [1−Φ(hⱼₜ)], and the support price, sⱼₜ, weighted by a probability of being in a government regime, Φ(hⱼₜ), over all of the more than one commodity.

83. The method of claim 80, wherein the multi-commodity price volatility forecasting function iteratively solves for the future market price volatility of the commodity j at the time interval t over all of the at least one commodities.

84. The method of claim 80, wherein the multi-commodity price volatility forecasting function comprises:
V(yⱼₜ)=σⱼₜ²·[1−Φ(hⱼₜ)+hⱼₜ·φ(hⱼₜ)+hⱼₜ²·Φ(hⱼₜ)−[hⱼₜ·Φ(hⱼₜ)+φ(hⱼₜ)]²] (2b)′
where σⱼₜ² is a price variance of the commodity j at time interval t in the absence of censoring, and [1−Φ(hⱼₜ)+hⱼₜ·φ(hⱼₜ)+hⱼₜ²·Φ(hⱼₜ)−[hⱼₜΦ(hⱼₜ)+φ(hⱼₜ)]²] measures a relative effect of the price support on the price volatility.

85. The method of claim 80, wherein the at least one commodity comprise butter, American cheese and non-fat dry milk.

86. An apparatus for forecasting a future market price and a price volatility of an at least one agricultural commodity for which a governmental support price is set, to aid in optimally allocating industrial or technological resources employed in the management and trading of said at least one commodity and stocks thereof, the apparatus comprising:
means for providing for the creation of an inputs database, comprising:
means for providing a definition of the at least one commodity;
means for providing for the specification of a time frame over which the future market price is to be forecasted, the time frame comprising a type of time interval and a number of time intervals;
means for providing a plurality of data from an at least one source database, the plurality of data comprising:
a set of recent past actual market prices of the at least one commodity;
a set of recent past amounts of stocks of the at least one commodity; and,
the support price of the at least one commodity;
means for providing for the accessible storage of the inputs database in said computer;
means for providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and, a time-varying price volatility function;
means for providing for the estimation of a value of each of the plurality of parameters by applying an estimation method to the set of specified price functions using the plurality of data;
means for providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
means for providing for the solution of a market price volatility forecasting function for the current time interval, thereby forecasting a future market price volatility of the at least one commodity at said time interval;
means for providing for the accessible storage of a results database in said computer comprising the future market price and the future price volatility of the at least one commodity;
if the number of time intervals is greater than one, means for iteratively repeating the solution of the price forecasting function, the solution of the price volatility function and the accessible storage of a results database steps for each time interval, and means for updating the inputs database with the previously forecasted future market price and future price volatility between each iteration; and,
means for providing for the output of said future market price and price volatility to aid in minimizing risk and allocating industrial or technological resources employed in the management or trading of said at least one commodity and stocks thereof.

87. The apparatus of claim 86, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

88. The apparatus of claim 86, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

89. The apparatus of claim 86, further comprising if more than one commodity is defined, means for repeating the solution of the price forecasting function for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

90. The apparatus of claim 89, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

91. A program storage device readable by a machine, tangibly embodying a program of instructions executable by the machine to perform method steps for forecasting a future market price and a price volatility of an at least one agricultural commodity for which a governmental support price is set, to aid in optimally allocating industrial or technological resources employed in the management and trading of said at least one commodity and stocks thereof, the method steps comprising:
providing for the creation of an inputs database, comprising:
providing a definition of the at least one commodity;
providing for the specification of a time frame over which the future market price is to be forecasted, the time frame comprising a type of time interval and a number of time intervals;
providing a plurality of data from an at least one source database, the plurality of data comprising:
a set of recent past actual market prices of the at least one commodity;
a set of recent past amounts of stocks of the at least one commodity; and,
the support price of the at least one commodity;
providing for the accessible storage of the inputs database in said computer;
providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
providing for the estimation of a value of each of the plurality of parameters by applying an estimation method to the set of specified price functions using the plurality of data;
providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
providing for the solution of a market price volatility forecasting function for the current time interval, thereby forecasting a future market price volatility of the at least one commodity at said time interval;
providing for the accessible storage of a results database in said computer comprising the future market price and the future price volatility of the at least one commodity;
if the number of time intervals is greater than one, iteratively repeating the providing for the solution of the price forecasting function, providing for the solution of the price volatility function and the providing for the accessible storage of a results database steps for each time interval and updating the inputs database with the previously forecasted future market price and future price volatility between each iteration; and,
providing for the output of said future market price and price volatility to aid in minimizing risk and allocating industrial or technological resources employed in the management or trading of said at least one commodity and stocks thereof.

92. The program storage device of claim 91, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

93. The program storage device of claim 91, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

94. The program storage device of claim 91, further comprising if more than one commodity is defined, repeating the solution of the price forecasting function step for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

95. The program storage device of claim 94, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

96. An article of manufacture comprising a computer-usable medium having computer-readable program code means embodied in said medium for forecasting a future market price and a price volatility of an at least one agricultural commodity for which a governmental support price is set, to aid in optimally allocating industrial or technological resources employed in the management and trading of said at least one commodity and stocks thereof, the computer-readable program code means comprising:
computer readable program code means for providing for the creation of an inputs database, comprising:
computer readable program code means for providing a definition of the at least one commodity;
computer readable program code means for providing for the specification of a time frame over which the future market price is to be forecasted, the time frame comprising a type of time interval and a number of time intervals;
computer readable program code means for providing a plurality of data from an at least one source database, the plurality of data comprising:
a set of recent past actual market prices of the at least one commodity;
a set of recent past amounts of stocks of the at least one commodity; and,
the support price of the at least one commodity;
computer readable program code means for providing for the accessible storage of the inputs database in said computer;
computer readable program code means for providing for the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
computer readable program code means for providing for the estimation of a value of each of the plurality of parameters by applying an estimation method to the set of specified price functions using the plurality of data;
computer readable program code means for providing for the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
computer readable program code means for providing for the solution of a market price volatility forecasting function for the current time interval, thereby forecasting a future market price volatility of the at least one commodity at said time interval;
computer readable program code means for providing for the accessible storage of a results database in said computer comprising the future market price and the future price volatility of the at least one commodity;
if the number of time intervals is greater than one, computer readable program code means for iteratively repeating the solution of the price forecasting function, the solution of the price volatility function and the accessible storage of a results database steps for each time interval and computer readable program code means for updating the inputs database with the previously forecasted future market price and future price volatility between each iteration; and,
computer readable program code means for providing for the output of said future market price and price volatility to aid in minimizing risk and allocating industrial or technological resources employed in the management or trading of said at least one commodity and stocks thereof

97. The article of manufacture of claim 96, wherein the price forecasting function solves for the future market price of the at least one commodity at the current time interval by taking an average of an expected price of said commodity under a market regime weighted by a probability of being in the market regime at said time interval, and the support price for said commodity weighted by the probability of being in a government regime at said time interval.

98. The article of manufacture of claim 96, wherein the price volatility forecasting function comprises:
V(yₜ)=σₜ²·[1−Φ(hₜ)+hₜ·φ(hₜ)+hₜ²·Φ(hₜ)−[hₜ·Φ(hₜ)+φ(hₜ)]²] (2b)
where σₜ² is a price variance in the absence of censoring, and [1−Φ(hₜ)+hₜ·φ(hₜ)+hₜ²·Φ(hₜ)−[hₜ·Φ(hₜ)+φ(hₜ)]²] measures a relative effect of the price support on the price volatility.

99. The article of manufacture of claim 96, further comprising if more than one commodity is defined, computer readable program code means for repeating the solution of the price forecasting function for each of the defined commodities where the set of specified price functions comprises a set of multi-commodity specified price functions, the price forecasting function comprises a multi-commodity price forecasting function and the price volatility forecasting function comprises a multi-commodity price volatility forecasting function.

100. The article of manufacture of claim 99, wherein the multi-commodity price forecasting function iteratively solves for the future market price of the commodity j at the time interval t by calculating a weighted average of an expected price of commodity j under a market regime weighted by a probability of being in the market regime at time interval t, and the support price of commodity j weighted by a probability of being in a government regime at time interval t, over all of the at least one commodities.

101. A computer program product comprising:
a computer usable medium and computer readable code embodied on said computer useable medium for causing the forecasting of a future market price and a price volatility of an at least one agricultural commodity for which a governmental support price is set, to aid in optimally allocating industrial or technological resources employed in the management and trading of said at least one commodity and stocks thereof, the computer-readable code comprising:
computer readable program code devices configured to cause the computer to effect the providing of the creation of an inputs database, comprising:
computer readable program code devices configured to cause the computer to effect the providing of a definition of the at least one commodity;
computer readable program code devices configured to cause the computer to effect the providing of the specification of a time frame over which the future market price is to be forecasted, the time frame comprising a type of time interval and a number of time intervals;
computer readable program code devices configured to cause the computer to effect the providing of a plurality of data from an at least one source database, the plurality of data comprising:
a set of recent past actual market prices of the at least one commodity;
a set of recent past amounts of stocks of the at least one commodity; and,
the support price of the at least one commodity;
computer readable program code devices configured to cause the computer to effect the providing of the accessible storage of the inputs database in said computer;
computer readable program code devices configured to cause the computer to effect the providing of the specification of a plurality of parameters of a price function to define a set of specified price functions for the at least one commodity, the set of specified price functions comprising:
a censoring regression function explicitly incorporating the support price;
a time-series function with a plurality of seasonal dummy variables; and,
a time-varying price volatility function;
computer readable program code devices configured to cause the computer to effect the providing of the estimation of a value of each of the plurality of parameters by applying an estimation method to the set of specified price functions using a plurality of data;
computer readable program code devices configured to cause the computer to effect the providing of the solution of a price forecasting function incorporating the plurality of parameter values for a current time interval, thereby forecasting the future market price of the at least one commodity at said current time interval, the price forecasting function comprising a dynamic censored-regression function jointly incorporating the price support and a time-series analysis;
computer readable program code devices configured to cause the computer to effect the providing of the solution of a market price volatility forecasting function for the current time interval, thereby forecasting a future market price volatility of the at least one commodity at said time interval;
computer readable program code devices configured to cause the computer to effect the providing of providing for the accessible storage of a results database in said computer comprising the future market price and the future price volatility of the at least one commodity;
if the number of time intervals is greater than one, computer readable program code devices configured to cause the computer to effect the iterative repeating of the solution of the price forecasting function, the solution of the price volatility function and the accessible storage of a results database steps for each time interval, and computer readable program code devices configured to cause the computer to effect the updating of the inputs database with the previously forecasted future market price and future price volatility between each iteration; and,
computer readable program code devices configured to cause the computer to effect the providing of the output of said future market price and price volatility to aid in minimizing risk and allocating industrial or technological resources employed in the management or trading of said at least one commodity and stocks thereof.
